(19) United States
(12) Patent Application Publication
(10) Pub. No.: US 2020/0125011 A1
(43) Pub. Date: Apr. 23, 2020

(54) IMAGE FORMING APPARATUS, METHOD FOR CONTROLLING IMAGE FORMING APPARATUS, AND PROGRAM FOR CONTROLLING IMAGE FORMING APPARATUS

(71) Applicant: Konica Minolta Inc., Tokyo (JP)

(72) Inventor: Yusuke Murakami, Okazaki-shi (JP)

(21) Appl. No.: 16/597,352

(22) Filed: Oct. 9, 2019

(30) Foreign Application Priority Data
Oct. 18, 2018 (JP) 2018-196512

(51) Int. Cl. G03G 15/16; G03G 15/00; G03G 21/00; G03G 15/04

(52) U.S. Cl. CPC G03G 15/1675; G03G 15/1605; G03G 15/556; G03G 15/505; G03G 2215/00059; G03G 21/0011; G03G 15/5037; G03G 15/04072; G03G 2215/0103; G03G 15/5004

(57) ABSTRACT

An image forming apparatus includes: a photoreceptor; a transferer; a remover that removes toner on a surface of the photoreceptor; and a hardware processor that: performs a control to form a toner image based on a print image on paper according to a first formation condition by using at least the photoreceptor and the transferer; performs a control to form a toner patch on the surface of the photoreceptor according to a second formation condition determined on the basis of the first formation condition at the time of forming the toner image on the paper by the hardware processor; and controls a voltage applied to the transferer to be a voltage at which the toner patch formed on the photoreceptor is not transferred when the toner patch formed on the surface of the photoreceptor passes through a region facing the transferer.

The entire disclosure of Japanese patent Application No. 2018-196512, filed on Oct. 18, 2018, is incorporated herein by reference in its entirety.

### BACKGROUND

### Technological Field

The present invention relates to an image forming apparatus, a method for controlling an image forming apparatus, and a program for controlling an image forming apparatus, and more particularly, to an image forming apparatus including a remover that removes residual toner remaining on a surface of a photoreceptor, a method for controlling an image forming apparatus, and a program for controlling an image forming apparatus.

### DESCRIPTION OF THE RELATED ART

Examples of an electrophotographic image forming apparatus include a multifunction peripheral (MFP) having a scanning, function, a facsimile function, a copying function, a printing function, a data communication function, and a server function, a facsimile machine, a copying, machine, and a printer.

In the image forming apparatus, generally, an electrostatic latent image is formed, by using an exposure device, on a surface of a photoreceptor electrified by an electrifying device, and the electrostatic latent image is developed by using a developing device to form a toner image. Next, in the image forming apparatus, the toner image on the surface of the photoreceptor is transferred onto paper by using a transfer roller, and then the toner image is fixed on the paper by using a fixing device. This way, the image forming apparatus forms an image on paper.

The image forming apparatus removes toner remaining on the surface of the photoreceptor by using a photoreceptor blade. Since the photoreceptor blade is in contact with the photoreceptor which rotates, the photoreceptor blade is required to have a certain degree of lubricity. The lubricity of the photoreceptor blade is secured by a lubricant contained in the toner attached to the photoreceptor blade. Therefore, a decrease in an amount of the toner attached to the photoreceptor blade causes problems such as damage to the photoreceptor blade and generation of residual toner (hereinafter, also referred to as an a) stripe) having a striped pattern along a circumferential direction of the surface of the photoreceptor, which results from deterioration in toner removing performance (cleaning performance) of the photoreceptor blade.

In order to suppress the decrease in an amount of the toner attached to the photoreceptor blade, in the image forming apparatus according to the related art, a toner patch is formed on the surface of the photoreceptor to supply the toner to the photoreceptor blade at a timing such as a timing at which low-coverage printing is continuously performed on a predetermined number of papers, a timing, at which a printing job is completed, or a timing between printing of an image and printing of another image among a plurality of images formed by a printing job.

In recent years, a situation in which an amount of toner supplied to the photoreceptor blade is insufficient has occurred frequently due to improvement in transfer efficiency, which results from a decrease in an amount of fogging toner (toner attached to a non-image part of the photoreceptor) caused by improvement in toner quality, and a decrease in diameter of a transfer roller. Thus, there is a need to more frequently (for example, each time one image is formed) form, on the surface of the photoreceptor, the toner patch for supplying the toner to the photoreceptor blade.

In general, once the toner patch is supplied to the surface of the photoreceptor, toner of the toner patch is attached to the transfer roller, such that a phenomenon (hereinafter, also referred to as back-side contamination) in which a back surface (a surface opposite to an image forming surface) of paper passing through the transfer roller is contaminated with the toner attached to the transfer roller can occur. The back-side contamination frequently occurs in a case where a density of the toner patch is excessively high.

In a case where the transfer roller is cleaned each time the toner patch for supplying the toner to the photoreceptor blade is formed, the occurrence of the back-side contamination is suppressed, but productivity of the image forming apparatus deteriorates. Occurrence and non-occurrence of the back-side contamination depends on the density of the toner patch. Therefore, it is required to control the density of the toner patch formed on the surface of the photoreceptor to prevent the hack-side contamination from occurring even in a case where cleaning of the transfer roller is not frequently performed.

Technologies of forming a toner patch according to the related art are disclosed in JP 2011-7831 A, JP 2015-94857 A, and the like. JP 2011-7831 A discloses a technology in which a toner image based on a patch for forcibly discharging toner is formed in a non-image region of a photoreceptor drum, and a polarity of a transfer belt is switched to be the same as that of the toner in a case where the non-image region of the photoreceptor drum abuts the transfer belt. In this technology, a bias reverse to that during printing is applied to the transfer belt when the toner patch passes through the transfer belt to prevent the toner patch from being transferred onto the transfer belt, thereby reducing contamination of a secondary transferer.

JP 2015-94857 A discloses an image forming apparatus in which a toner image is formed in a non-image region of an intermediate transfer belt, such that operation in a mode in which toner is supplied to an intermediate transfer belt cleaning blade is possible. In this image forming apparatus, when forming the toner image on the non-image region, an image forming engine determines whether to form a toner image (a toner image that does not need to be cleaned) with pattern B based on image information processed by a controller, or a toner image (a toner image that needs to be cleaned) with pattern C that is not based on the image information depending on a time required for forming the respective toner images.

The density of the toner patch varies depending on various factors such as an environment (humidity), a toner-carrier ratio, and a distance between the developing device and the photoreceptor, even in a case where a light intensity of the exposure device is constant. Therefore, in the technology according to related art, it has been difficult to appropriately control the density of the toner patch, so that the back-side contamination is prevented from occurring even in a case where cleaning of the transfer roller is not frequently performed.

In the technology disclosed in JP 2011-7831 A, in a case where the density of the toner patch is higher than desired, the toner patch is attached to the transfer belt, such that it is not possible to suppress occurrence of the back-side contamination.

Further, in the technology disclosed in JP 2015-94857 A, formation of a toner patch with pattern B, of which a toner density is constant, is implemented by processing performed by a controller. However, in this technology, processing for creating an image of the toner patch is required, such that productivity of the image forming apparatus deteriorates, which is problematic. Further, in a case of forming, a toner image with pattern. C that is not based on image information, it is required to perform cleaning after forming the toner patch, such that productivity of the image forming apparatus deteriorates, which is problematic.

### SUMMARY

An object of the present invention is to provide an image forming apparatus, a method for controlling an image forming apparatus, and a program for controlling an image forming apparatus, which can suppress deterioration in productivity and occurrence of back-side contamination.

To achieve the abovementioned object, according to an aspect of the present invention, an image forming apparatus reflecting one aspect of the present invention comprises: a photoreceptor; a transferer; a remover that removes toner on a surface of the photoreceptor; and a hardware processor that: performs a control to form a toner image based on a print image on paper according to a first formation condition by using at least the photoreceptor and the transferer; performs a control to form a toner patch on the surface of the photoreceptor according to a second formation condition determined on the basis of the first formation condition at the time of forming the toner image on the paper by the hardware processor; and controls a voltage applied to the transferer to be a voltage at which the toner patch formed on the photoreceptor is not transferred when the toner patch formed on the surface of the photoreceptor passes through a region facing the transferer.

### BRIEF DESCRIPTION OF THE DRAWINGS

The advantages and features provided, by one or more embodiments of the invention will become more fully understood from the detailed description given hereinbelow and the appended drawings winch are given by way of illustration only, and thus are not intended as a definition of the limits of the present invention:

FIG. 1 is a cross-sectional view schematically showing a configuration of an image forming apparatus according to a first embodiment of the present invention;

FIG. 2 is a block diagram showing a configuration of the image forming apparatus according to the first embodiment of the present invention;

FIG. 3 is a diagram schematically showing toner images formed on a surface of a photoreceptor according to the first embodiment of the present invention;

FIG. 4 is a diagram showing light emission of an exposure unit, and a change in voltage over time in a case where the image forming apparatus according to the first embodiment of the present invention performs a printing job, the voltage being applied to each of a primary transferer and a secondary transferer;

FIG. 5 schematically shows an environment value table stored in a read only memory (ROM) according to tire first embodiment of the present invention;

FIGS. 6A and 6B schematically show a first part of a reference light intensity table stored in the ROM according to the first embodiment of the present invention;

FIGS. 7A and 7B schematically show a second part of the reference light intensity table stored in the ROM according to the first embodiment of the present invention;

FIG. 8 schematically shows a table of a light intensity correction coefficient according to a developing bias, the table being stored in the ROM according to the first embodiment of the present invention;

FIG. 9 schematically shows a table of a light intensity correction coefficient according to a laser light intensity, the table being stored in the ROM according to the first embodiment of the present invention;

FIG. 10 is a flowchart showing operation of the image forming apparatus according to the first embodiment of the present invention;

FIG. 11 shows a subroutine of toner patch processing of FIG. 10 according to the first embodiment of the present invention;

FIG. 12 is a diagram showing an example of a change in voltage over time in a case where the image forming apparatus performs a printing job according to a second embodiment of the present invention, the voltage being applied to each of the electrifier, the developer, the primary transferer, and the secondary transferer;

FIG. 13 is a diagram showing another example of the change in voltage over time in a case where the image forming apparatus performs a printing job according to the second embodiment of the present invention, the voltage being applied to each of the electrifier, the developer, the primary transferer, and the secondary transferer;

FIGS. 14A and 14B schematically show a first part of a reference fogging margin table stored, in a ROM according to the second embodiment of the present invention;

FIGS. 15A and 15B schematically show a second part of the reference fogging margin table stored in the ROM according to the second embodiment of the present invention;

FIG. 16 schematically shows a table of a fogging margin correction coefficient according to a developing bias, the table being stored in the ROM according to the second embodiment of the present invention;

FIG. 17 schematically shows a table of a fogging margin correction coefficient according to a laser light intensity, the table being stored in the ROM according to the second embodiment of the present invention;

FIG. 18 shows a subroutine of toner patch processing of FIG. 10 according to the second embodiment of the present invention, which is a subroutine of toner patch processing in a case of controlling an electrifying bias at the time of forming a toner patch;

FIG. 19 shows a subroutine of the toner patch processing of FIG. 10 according to the second embodiment of the present invention, which is a subroutine of toner patch processing in a case of controlling a developing bias at the time of forming a toner patch;

FIG. 20 is a diagram showing a relation between an amount of a toner patch on a surface of an intermediate transfer body, and a back-side contamination threshold and an FD stripe threshold according to a third embodiment of the present invention;

FIG. 21 schematically shows a primary transfer efficiency table stored in a ROM according to the third embodiment of the present invention;

FIG. 22 schematically shows an FD stripe threshold table stored in the ROM according to the third embodiment of the present invention,

FIG. 23 shows a subroutine of toner patch density detection processing of FIG. 10 according to the third embodiment of the present invention,

FIG. 24 is a diagram showing a relation between the number of colors of toner patches overlappingly transferred onto a surface of an intermediate transfer body, and an amount of the toner patches on the surface of the intermediate transfer body according to the third embodiment of the present invention;

FIG. 25 shows a subroutine of toner patch density detection processing of FIG. 10 according to a first modified example of the third embodiment of the present invention;

FIG. 26 is a diagram schematically showing toner images formed on the surface of the intermediate transfer body according to a second modified example of the third embodiment of the present invention;

FIG. 27 shows a subroutine of toner patch density detection processing of FIG. 10 according to the second modified example of the third embodiment of the present invention;

FIG. 28 schematically shows a patch formation necessity determination table stored in the ROM according to another embodiment of the present invention;

FIGS. 29A and 29B each schematically show a patch formation timing table stored in the ROM according to another embodiment of the present invention; and

FIG. 30 schematically shows a patch length table stored in the ROM according to another embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

In the following embodiments, a case where an image forming apparatus is a multifunction peripheral (MFP) will be described. The image forming apparatus may also be a facsimile machine, a copying machine, a printer, or the like, instead of the MFP, and may be for monochrome or color printing.

### First Embodiment

(Configuration of Image Forming Apparatus)

First, a configuration of an image forming apparatus according to the present embodiment will be described.

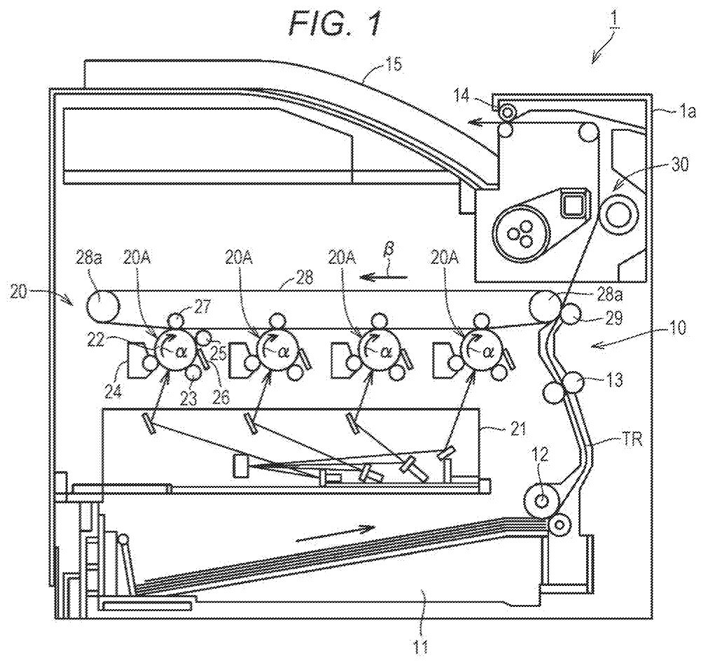

FIG. 1 is a cross-sectional view schematically showing a configuration of an image forming apparatus 1 according to a first embodiment of the present invention.

Referring to FIG. 1, the image forming apparatus 1 (an example of the image forming apparatus) according to the present embodiment is an MFP, and mainly includes a paper transporter 10, a toner image former 20, and a fixing device 30.

The paper transporter 10 transports paper along a transport route (transport direction) TR. The paper transporter 10 includes a feeding tray 11, a feeding roller 12, a resist roller 13, a discharge roller 14, and a discharge tray 15. The feeding tray 11 accommodates paper for image formation. The number of feeding trays 11 may be plural. The feeding roller 12 is provided between the feeding tray 11 and the transport route TR. The resist roller 13 is provided on a further upstream side in the transport route TR in comparison to a secondary transferer 29. The discharge roller 14 is provided on the most downstream side in the transport route TR. The discharge tray 15 is provided on the uppermost part of a main body 1a of the image forming apparatus.

The toner image former 20 composites images of four colors including yellow (Y), magenta (M), cyan (C), and black (K) by a so-called tandem method, and forms a toner image on the transported paper. The toner image former 20 includes image forming units 20A for the respective colors of YMCK, an exposure unit 21 (an example of a laser light irradiator), primary transferers 27 (an example of a transferer) for the respective colors of YMCK, an intermediate transfer body 28 (an example of an intermediate transfer body), and a secondary transferer 29 (an example of a secondary transferer).

The image forming units 20A for the respective colors of YMCK are provided between the exposure unit 21 and the intermediate transfer body 28, sequentially along a rotation direction of the intermediate transfer body 28, the rotation direction being indicated by an arrow β. The image forming units 20A for the respective colors of YMCK each include a photoreceptor 22 (an example of a photoreceptor), an electrifier 23 (an example of an electrifier), a developer 24 (an example of a developer), an eraser 25, a photoreceptor blade 26 (an example of a remover), and the like. The photoreceptor 22 rotates in a direction indicated by an arrow α of FIG. 1. The electrifier 23, the developer 24, the eraser 25, and the photoreceptor blade 26 are sequentially provided around the photoreceptor 22 along the direction indicated by the arrow α.

The intermediate transfer body 28 is provided over the image forming units 20A for the respective colors of YMCK. The intermediate transfer body 28 is an endless belt and is supported on rotation rollers 28a. The intermediate transfer body 28 rotates in the direction indicated by the arrow β of FIG. 1. The primary transferers 27 for the respective colors of YMCK face the photoreceptors 22, respectively, while having the intermediate transfer body 28 interposed therebetween. The secondary transferer 29 is in contact with the intermediate transfer body 28 in the transport route TR. The photoreceptor 22 is in contact with a surface of the intermediate transfer body 28.

The fixing device 30 transports the paper on which the toner image is formed along the transport route TR while holding the paper by using a fixing nip, thereby fixing the toner image on the paper.

In the image forming apparatus 1, the photoreceptor 22 rotates, such that the electrifier 23 uniformly electrifies a surface of the photoreceptor 22. In the image forming apparatus 1, the electrified surface of the photoreceptor 22 is exposed to laser light emitted from the exposure unit 21 according to image forming information to form, on the surface of the photoreceptor 22, an electrostatic latent image as a base of a toner image.

Next, in the image forming apparatus 1, toner is supplied to the photoreceptor 22 on which the electrostatic latent image is formed from the developer 24 to perform developing, thereby forming a toner image on the surface of the photoreceptor 22.

Next, in the image forming apparatus 1, the toner image formed on the surface of the photoreceptor 22 is sequentially transferred onto the surface of the intermediate transfer body 28 by using the primary transferer 27 at a position at which the photoreceptor 22 is in contact with the intermediate transfer body 28 (military transfer). In a case of a full-color image, respective colors are overlapped in the toner image transferred onto the intermediate transfer body 28 each time the intermediate transfer body 28 passes through each of the image forming units 20A, such that a full-color toner image is finally formed on the intermediate transfer body 28. In the image forming apparatus 1, an electron remaining on the surface of the photoreceptor 22 after the primary transfer is removed by the eraser 25, and the toner remaining on the surface of the photoreceptor 22 without being transferred onto the intermediate transfer body 28 is removed by the photoreceptor blade 26.

Next, in the image forming apparatus 1, the toner image formed on the surface of the intermediate transfer body 28 is transported to a position facing the secondary transferer 29 by the rotation roller 28a.

Meanwhile, in the image forming apparatus 1, the paper accommodated in the feeding tray 11 is fed by the feeding roller 12 one by one, and is guided to a position between the intermediate transfer body 28 and the secondary transferer 29 by the resist roller 13 at a predetermined tinting. Then, in the image forming apparatus 1., the toner image formed on the surface of the intermediate transfer body 28 is transferred onto the paper by the secondary transferer 29.

In the image forming apparatus 1, the paper onto which the toner image is transferred is guided to the fixing device 30 and the toner image is fixed to the paper by the fixing device 30. Then, in the image forming apparatus 1, the paper to which the toner image is fixed is discharged to the discharge tray 15 by the discharge roller 14.

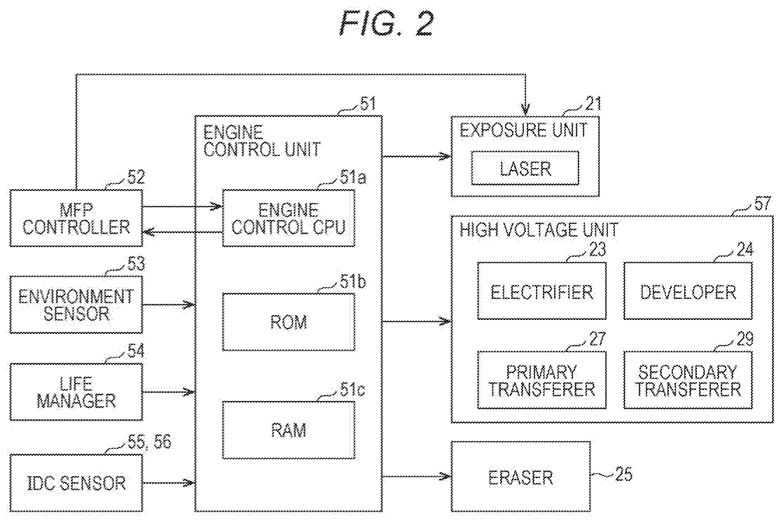

FIG. 2 is a block diagram showing a configuration of the image forming apparatus 1 according to the first embodiment of the present invention.

Referring to FIG. 2, the image forming apparatus 1 further includes an engine control unit 51, an MFP controller 52 (an example of a printing controlling unit), an environment sensor 53, a life manager 54, and image density control (IDC) sensors 55 and 56 (an example of a density detector).

The electrifier 23, the developer 24, the primary transferer 27, and the secondary transferer 29, which are members receiving power from a high-voltage power source (not shown), constitute a high voltage unit 57.

The engine control unit 51 controls operation of members (print engine) such as the exposure unit 21, the eraser 25, the high voltage unit 57, and the like under a control of the MFP controller 52, the members relating to a printing operation in the image forming apparatus 1. The engine control unit 51 includes an engine control central processing unit (CPU) 51a (an example of a toner patch formation controlling unit, a transfer voltage controlling unit, a condition corrector, a color number corrector, a position corrector, a formation determiner, a timing determiner, and a length determiner) that executes a control program, a read only memory (ROM) 51b (an example of a storage device) that stores various pieces of information such as the control program, and a random access memory (RAM) 51c that temporarily stores various pieces of information.

The NET controller 52 controls the entire image forming apparatus 1. Particularly, the MFP controller 52 transmits, to the exposure unit 21, exposure information according to a print image included in a printing job. The exposure unit 21 allows an electrostatic latent image based on the exposure information received from the MFP controller 52 to be formed on the surface of the photoreceptor 22. The MFP controller 52 includes a CPU, a ROM, a RAM, and the like.

The environment sensor 53 detects an environment (here, an absolute humidity value in the image forming apparatus 1) of the image forming apparatus 1 and outputs a result of the detection to the engine control unit 51.

The life manager 54 detects a consumption degree of consumables of the image forming apparatus 1, such as the cumulative number of rotations of the photoreceptor 22, and outputs the detected consumption degree to the engine control unit 51.

The IDC sensor 55 detects a density of the toner image remaining on the surface of the photoreceptor 22 without being transferred and outputs the detected density to the engine control unit 51.

The IDC sensor 56 detects a density of the toner image formed on the surface of the intermediate transfer body 28 and outputs the detected density to the engine control unit 51.

(Basic Operation of Image Forming Apparatus)

Next, basic operation of the image forming apparatus 1 according to the present embodiment will be described.

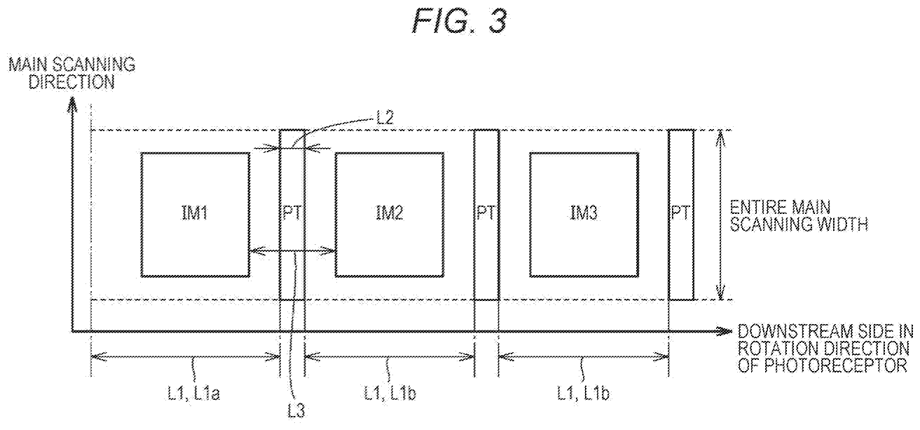

FIG. 3 is a diagram schematically showing toner images formed on the surface of the photoreceptor 22 according to the first embodiment of the present invention.

Referring to FIG. 3, once an instruction to perform a printing job is received, the MFP controller 52 generates data of a plurality of (here, three) print images IM1, IM2, and IM3 included in the printing job. The MFP controller 52 controls the engine control unit 51 to sequentially form toner images based on the print images IM1, IM2, and IM3 on the surface of the photoreceptor 22 at predetermined intervals L3 according to a predetermined formation condition.

In a case where the toner images of the plurality of print images IM1, IM2, and IM3 are sequentially formed on the surface of the photoreceptor 22, the engine control unit 51 forms a toner patch PT at at least one of a position between the respective toner images of the plurality of print images IM1, IM2, and IM3, and a position next to the toner image of the last print image IM3 in the printing job, on the surface of the photoreceptor 22. Here, the toner patch PT is formed at each of a position between time toner image of the print image IM1 and the toner image of the print image IM2, a position between the toner image of the print image IM2 and the toner image of the print image IM3, and the position next to the toner image of the last print image IM3.

Note that a distance L1 is a distance from a position at which the photoreceptor 22 starts to rotate when the printing job starts to a position at which the toner patch formation starts, or a distance from a position at which the previous toner patch formation ends to a position at which the next toner patch formation starts. A length L2 is a length of the toner patch PT in a circumferential direction of the photoreceptor 22. It is preferable that the toner patch PT is formed while having the same width as the entire width of an image forming region in a main scanning direction in order to supply toner to a region requiring the toner for the photoreceptor blade 26.

At the time of forming the toner images of the print images IM1, IM2, and IM3, the engine control unit 51 controls the print engine under the control of the MFP controller 52. Meanwhile, at the time of forming the toner patch PT, the engine control unit 51 controls (for example, performs a forced light emission of the exposure unit 21) the print engine without the control of the MFP controller 52.

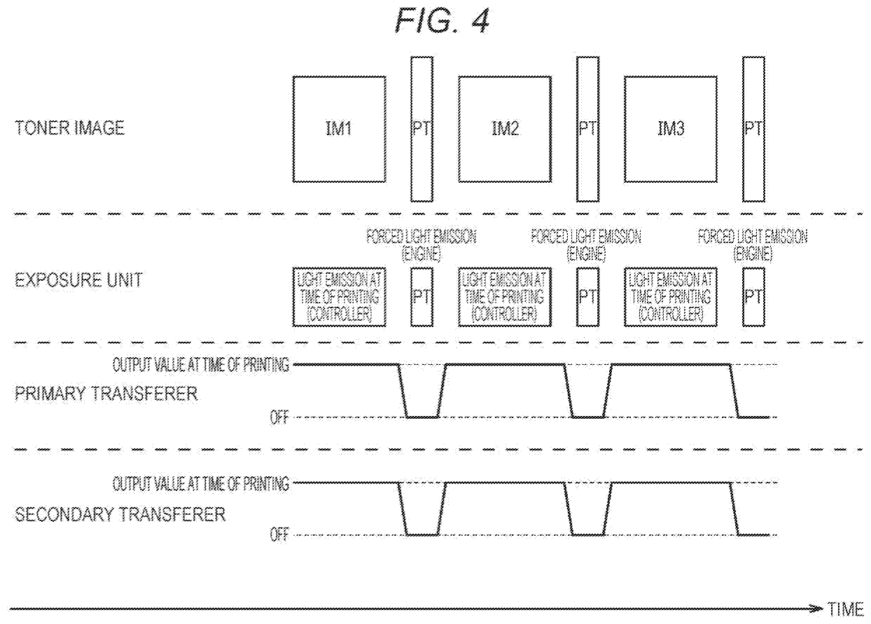

FIG. 4 is a diagram showing light emission of the exposure unit 21, and a change in voltage over tune in a case where the image forming apparatus 1 according to the first embodiment of the present invention performs a printing job, the voltage being applied to each of the primary transferer 27 and the secondary transferer 29.

Referring to FIG. 4, the engine control unit 51 forms an electrostatic latent image of each of the print images IM1, IM2, and IM3 by irradiation of laser light from the exposure unit 21 under the control of the MFP controller 52 at a timing at which a region on the surface of the photoreceptor 22, in which the electrostatic latent image of each of the print images IM1, IM2, and IM3 is to be formed, passes through a laser light irradiation region.

Once the printing job starts, the engine control unit 51 applies a voltage corresponding to an output value at the time of printing to each of the electrifier 23 and the developer 24 under the control of the MFP controller 52 (note that output values of the electrifier 23, the developer 24, the primary transferer 27, and the secondary transferer 29 at the time of printing are different from one another). By doing so, the toner images of the print images IM1, IM2, and IM3 are formed on the surface of the photoreceptor 22. The toner images of the print images IM1, IM2, and IM3 are transferred onto the intermediate transfer body 28, and then are sequentially transferred onto the paper passing between the intermediate transfer body 28 and the secondary transferer 29.

A condition (for example, the output values of the electrifier 23, the developer 24, the primary transferer 27, and the secondary transferer 29 at the time of printing) for forming the print images IM1, IM2, and IM3 may be a condition determined by image stabilization processing performed at a timing different from a timing at which the printing job is performed by the image forming apparatus 1, or may be a condition determined on the basis of at least any one of the environment of the image forming, apparatus 1 and the consumption degree of the consumables of the image forming apparatus 1.

Meanwhile, the engine control unit 51 forms an electrostatic latent image of each of a plurality of toner patches PT by irradiation (a forced light emission of the exposure unit 21) of laser light from the exposure unit 21, without the control of the MFP controller 52 at a timing at which a region on the surface of the photoreceptor 22, in which the electrostatic latent image of each of the toner patches PT is to be formed, passes through the laser light irradiation region.

The engine control unit 51 controls a voltage applied to the primary transferer 27 to be a voltage at which the toner patch PT formed on the photoreceptor 22 is not transferred, without the control of the MFP controller 52 at a timing at which a toner image of the toner patch PT formed on the surface of the photoreceptor 22 passes through a region facing the primary transferer 27. By doing so, the majority of the toner of the toner patch PT formed on the surface of the photoreceptor 22 is supplied to the photoreceptor blade 26 and is hardly attached to tire intermediate transfer body 28.

The voltage at which the toner patch formed on the photoreceptor 22 is not transferred is a voltage lower than a voltage at the time of forming the toner image of the print image, a zero voltage, or a voltage at which a, potential of the primary transferer 27 becomes the same as that of the toner patch formed on the photoreceptor 22.

The engine control unit 51 controls a voltage applied to the secondary transferer 29 to the a voltage at which the toner patch PT formed on the intermediate transfer body 28 is not transferred, without the control of the MFP controller 52 at a timing at which a toner image of the toner patch PT formed on the surface of the intermediate transfer body 28 passes through a region facing the secondary transferer 29. By doing so, the toner of the toner patch PT formed on the surface of the intermediate transfer body 28 remains on the intermediate transfer body 28 and is hardly attached to the secondary transferer 29.

The voltage at which the toner patch formed on the intermediate transfer body 28 is not transferred is a voltage lower than the voltage at the time of forming the toner image of the print image, a zero voltage, or a voltage at which a potential of the secondary transferer 29 becomes the same as that of the toner patch formed on the intermediate transfer body 28.

In a case where the toner patch PT is supplied to the photoreceptor blade 26, the engine control unit 51 forms the toner patch PT on the surface of the photoreceptor 22 according to a toner patch (PT) formation condition (an example of a second formation condition) determined on the basis of a print image formation condition (an example of a first formation condition).

According to the present embodiment, an intensity of laser light emitted from the exposure unit 21 at the time of forming the toner patch is determined, as the toner patch formation condition. Laser light having the determined intensity is emitted at the time of forming the toner patch.

(Method of Determining Toner Patch Formation Condition)

Next, a method of determining the toner patch formation condition according to the present embodiment will be described.

The engine control unit 51 determines an environment value on the basis of an absolute humidity value acquired from the environment sensor 53 by using an environment value table when determining the toner patch formation condition. Next, the engine control unit 51 determines the reference light intensity by using a reference light intensity table. The reference light intensity is determined on the basis of a resolution of the print image, a peripheral speed (rotation speed) of the photoreceptor 22, a color of the toner image formed on the photoreceptor 22, the cumulative number of rotations of the photoreceptor 22 acquired from the life manager 54, and, the environment value determined by using the environment value table.

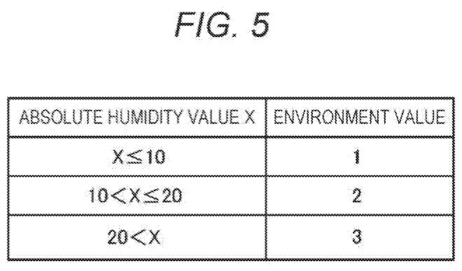

FIG. 5 schematically shows an environment value table stored in the ROM 51b according to the first embodiment of the present invention.

Referring to FIG. 5, the environment value table is a table describing a relation between an environment (here, an absolute humidity value in the image forming apparatus 1) of the image forming apparatus 1, and an environment value. In this environment value table, it is defined that the environment value is “1” in a case where an absolute humidity value X is less than 10, the environment value is “2” in a case where the absolute humidity value X is 10 or more and less than 20, and the environment value is “3” in a case where the absolute humidity value X is 20 or more.

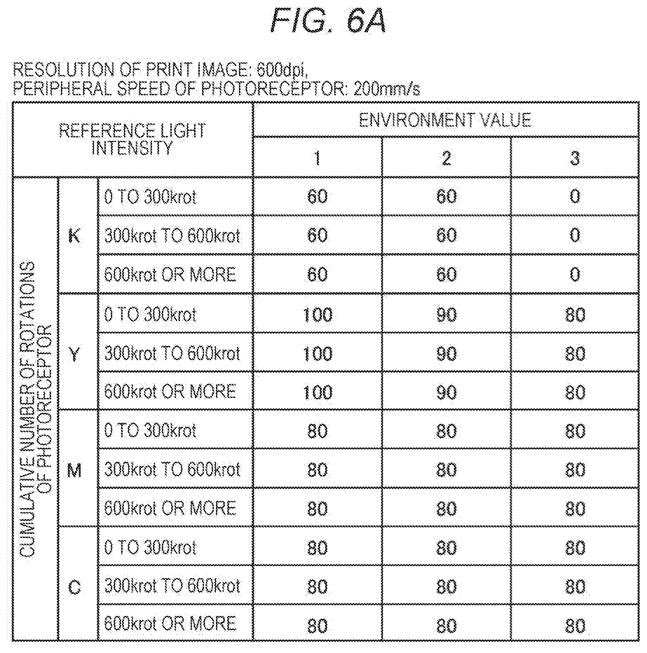

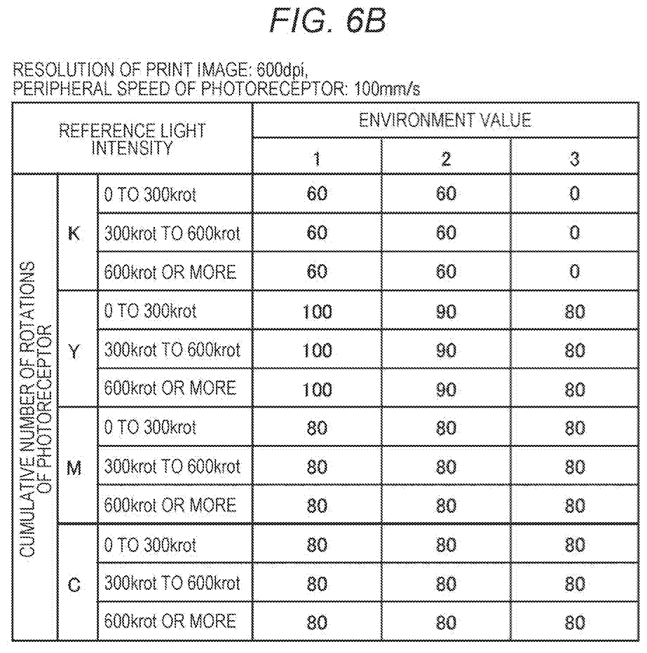

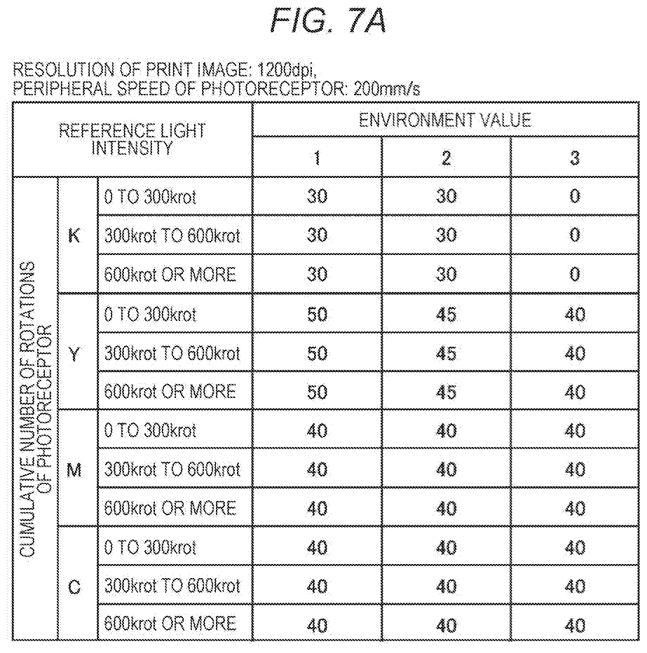

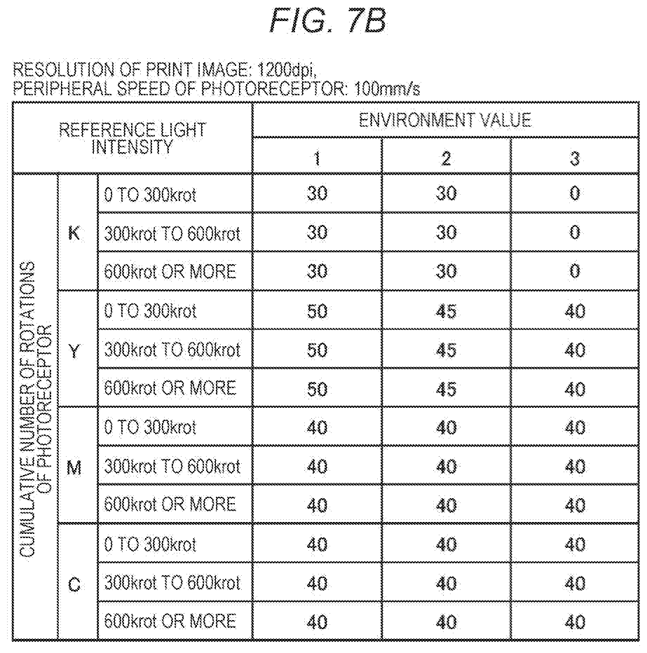

FIGS. 6A to 7B each schematically show a reference light intensity table stored in the ROM 51b according to the first embodiment of the present invention.

Referring to FIGS. 6A to 7B, the reference light intensity table is a table describing a relation between a reference light intensity (mJ/m²), and a resolution of the print image, a peripheral speed of the photoreceptor 22, a color of the toner image formed on the photoreceptor 22, the cumulative number of rotations of the photoreceptor 22 acquired from the life manager 54, and an environment value determined by using the environment value table, the reference light intensity being a reference value of the intensity of laser light emitted from the exposure unit 21 at the time of forming the toner patch. The reference light intensity table defines a light intensity which is a reference for supplying, to the photoreceptor blade 26, the toner in an amount which does not cause the FD stripe and the back-side contamination.

Specifically, four reference light intensity tables are shown in FIGS. 6A to 7B, respectively. In a case where the resolution of the print image is 600 dpi, the reference light intensity tables of FIGS. 6A and 63 are referred to, and in a case where the resolution of the print image is 1200 dpi, the reference light intensity tables of FIGS. 7A and 7B are referred to. In a case where the peripheral speed (rotation speed) of the photoreceptor is 200 mm/s, the reference light intensity table of FIG. 6A or 7A in which “peripheral speed of photoreceptor: 200 mm/s” is described is referred to, and in a case where the peripheral speed of the photoreceptor is 100 mm/s, the reference light intensity table of FIG. 6B or 7B in which “peripheral speed of photoreceptor: 100 mm/s” is described is referred to.

In one reference light intensity table, the color of the toner image formed on the photoreceptor, and the cumulative number of rotations of the photoreceptor are divided in a vertical direction. The color of the toner image formed on the photoreceptor is divided into four colors of KYMC, and the cumulative number of rotations of the photoreceptor is divided into three ranges of less than 300 krot, 300 krot or more and less than 600 krot, and 600 krot or more. In one reference light intensity table, the environment value is divided into three values of 1 to 3 in a horizontal direction.

As an example, in a case where the resolution of the print image is 600 dpi, the peripheral speed of the photoreceptor is 200 mm/s, the color of the toner image formed on the photoreceptor is K, the cumulative number of rotations of the photoreceptor is 300 krot or more and less than 600 krot, and the environment value is “2”, the reference light intensity is determined to be “60 (mJ/m²)”.

Note that the print image formation condition used for determination of the toner patch formation condition may include at least one parameter among the rotation speed of the photoreceptor 22, the color of the toner image formed on the photoreceptor 22, a consumption degree of the photoreceptor 22, the environment of the image forming apparatus 1, and the resolution of the print image.

The engine control unit 51 may allow laser light having the determined reference light intensity to be emitted at the time of forming the toner patch. Further, the engine control unit 51 may correct the determined reference light intensity on the basis of at least one of a developing bias and the laser light intensity at the time of forming the toner image based on the print image. In this case, laser light having a corrected intensity is emitted at the time of forming the toner patch.

Next, a method of correcting the reference light intensity according to the present embodiment will be described.

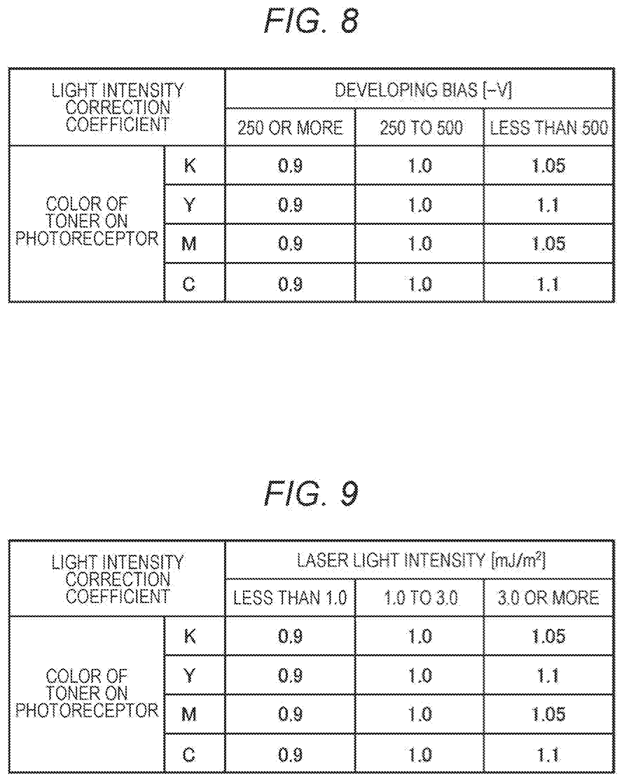

FIG. 8 schematically shows a table of a light intensity correction coefficient according to a developing bias, the table being stored in the ROM 51b according to the first embodiment of the present invention.

Referring to FIG. 8, the table (hereinafter, referred to as a light intensity correction coefficient table) of a light intensity correction coefficient according to a developing bias is a table describing a relation between the developing bias (a voltage applied to the developer 24) at the nine of forming the toner image based on the print image, and the light intensity correction coefficient. This light intensity correction coefficient table is provided for correction of the reference light intensity determined by using the reference light intensity table according to a developing characteristic. In this light intensity correction coefficient table, the color of the toner image formed on the photoreceptor is divided into four colors of KYMC in a vertical direction. Further, in this light intensity correction coefficient table, the developing bias is divided into three ranges of −250 V or more, −500 V or more and less than −250 V, and less than −500 V in a horizontal direction.

As an example, in a case where the color of the toner image formed on the photoreceptor is K, and the developing bias at the time of forming the toner image based ° tithe print image is less than −500 V, the light intensity correction coefficient is determined to be “1.05”.

The engine control unit 51 corrects (calculates) the laser light intensity at the time of forming the toner patch by using the following Expression (1).

Laser light intensity (mJ/m²) at the time of forming toner patch=Reference light intensity (mJ/m²)×Light intensity correction coefficient (1)

FIG. 9 schematically shows a table of a light intensity correction coefficient according to a laser light intensity, the table being stored in the ROM 51b according to the first embodiment of the present invention.

Referring to FIG. 9, the table (hereinafter, referred to as a light intensity correction coefficient table) of a light intensity correction coefficient according to a laser light intensity is a table describing a relation between the laser light intensity (an intensity of laser light emitted from the exposure unit 21) at the time of forming the toner image based on the print image, and the light intensity correction coefficient. This light intensity correction coefficient table is provided for correction of the reference light intensity determined by using the reference light intensity table according to an exposure characteristic. In this light intensity correction coefficient table, the color of the toner image formed on the photoreceptor is divided into four colors of KYMC in a vertical direction. Further, in this light intensity correction coefficient table, the laser light intensity is divided into three ranges of less than 1.0 mJ/m², 1.0 mJ/m² or more and less than 3.0 mJ/m², and 3.0 mJ/m² or more in a horizontal direction.

As an example, in a case where the color of the toner image formed on the photoreceptor is K, and the laser light intensity at the time of forming the toner image based on the print image is less than 1.0 mJ/m², the light intensity correction coefficient is determined to be “0.9”.

The engine control unit 51 corrects (calculates) the laser light intensity at the time of forming the toner patch by using Expression (1).

As the laser light intensity determined by the above-described method is used at the time of forming the toner patch, the toner is supplied to the photoreceptor blade 26, the density of the toner patch PT is appropriately set on the basis of the print image formation condition, and contamination of the secondary transferer 29 with the toner of the toner patch is suppressed.

(Flowchart)

Next, a flowchart of operation of the image forming apparatus according to the present embodiment will be described.

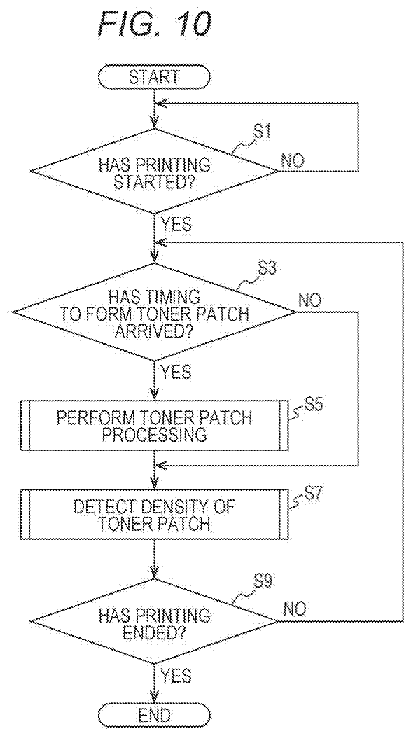

FIG. 10 is a flowchart showing operation of the image forming apparatus 1 according to the first embodiment of the present invention.

Referring to FIG. 10, the engine control CPU 51a determines whether or not the printing operation of the printing job has started (S1). The engine control CPU 51a repeats the processing of Step S1 until it is determined that the printing operation of the printing job has started.

In Step S1, in a case where it is determined that the printing operation of the printing job has started (YES in S1), the engine control CPU 51a determines whether or not a timing to form the toner patch has arrived (S3).

In Step S3, in a case where it is determined that the timing to form the toner patch has not arrived (NO in S3), the engine control CPU 51a proceeds to processing of Step S7.

In Step S3, in a case where it is determined that the timing to form the toner patch has arrived (YES in S3), the engine control CPU 51a performs toner patch processing to be described later (S5) and proceeds to processing of Step S7.

In Step S7, the engine control CPU 51a performs toner patch density detection processing (57) to be described later as necessary, and determines whether or not the printing operation of the printing job has ended (S9).

In Step S9, in a case where it is determined that the printing operation of the printing job has not ended (NO in S9), the engine control CPU 51a proceeds to processing of Step S3.

In Step S9, in a case where it is determined that the printing operation of the printing: job has ended (YES in S9), the engine control CPU 51a, ends processing.

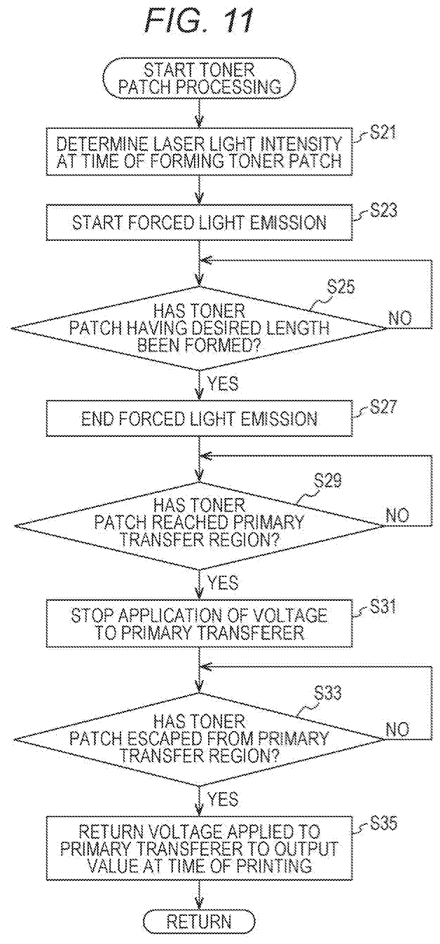

FIG. 11 shows a subroutine of the toner patch processing (S5) of FIG. 10 according to the first embodiment of the present invention.

Referring to FIG. 11 in the toner patch processing, the engine control CPU 51a determines the laser light intensity at the time of forming the toner patch (S21), and starts a forced light emission of the exposure unit 21 (S23). Next, tire engine control CPU 51a determines whether or not an electrostatic latent image corresponding to a toner patch having a desired length has been formed on the surface of the photoreceptor 22 (S25). Tire engine control CPU 51a repeats the processing of Step S25 until it is determined that the electrostatic latent image corresponding to the toner patch having the desired length has been formed on the surface of the photoreceptor 22.

In Step S25, in a case where it is determined that the electrostatic latent image corresponding to the toner patch having the desired length has been formed on the surface of the photoreceptor 22 (YES in S25), the engine control CPU 51a ends the forced light emission of the exposure unit 21 (S27). Next, the engine control CPU 51a, performs a control to form the toner patch by developing the electrostatic latent image and determines whether or not the toner patch formed on the surface of the photoreceptor 22 has reached a primary transfer region (a region facing the primary transferer 27) (S29). The engine control CPU 51a repeats the processing of Step S29 until it is determined that the toner patch formed on the surface of the photoreceptor 22 has reached the primary transfer region.

In Step S29, in a case where it is determined that the toner patch formed on the surface of the photoreceptor 22 has reached the primary transfer region (YES in S29), the engine control CPU 51a stops application of a voltage to the primary transferer 27 (S31), and determines whether or not the toner patch formed on the surface of the photoreceptor 22 has escaped from the prima transfer region (S33). The engine control CPU 51a repeats the processing of Step S33 until it is determined that the toner patch formed on the surface of the photoreceptor 22 has escaped from the primary transfer region.

In Step S33, in a case where it is determined that the toner patch formed on the surface of the photoreceptor 22 has escaped from the primary transfer region (YES in S33), the engine control CPU 51a returns the voltage applied to the primary transferer 27 to the output value at the time of printing (S35) and returns to a main routine in FIG. 10.

According to the present embodiment, tire electrostatic latent image is formed on the surface of the photoreceptor 22 with the laser light intensity determined on the basis of the formation condition at the time of forming, on the paper, the toner image based on the print image, such that it is possible to appropriately set the density of the toner patch formed on the surface of the photoreceptor 22. As a result, the contamination of the secondary transferer 29 with the toner of the toner patch having an excessive density is suppressed, such that it is not necessary to frequently perform the cleaning of the secondary transferer 29. As a result, it is possible to suppress occurrence of the back-side contamination and the FD stripe while suppressing the deterioration in productivity Further, since processing for creating an image of the toner patch is unnecessary, it is possible to suppress the deterioration in productivity. In addition, it is possible to decrease an amount of toner used for the toner patch.

### Second Embodiment

In the present embodiment, a fogging margin is determined as a toner patch formation condition. Developing is performed with the determined fogging margin at the time of forming the toner patch PT. By doing so, the toner is supplied to the photoreceptor blade 26, the density of the toner patch PT is appropriately set, and contamination of the secondary transferer 29 with the toner of the toner patch PT is suppressed.

In a case where a potential of the photoreceptor 22 after the electrifying and a potential of the developer 24 are the same as each other, it is apprehended that the toner of the developer 24 is unnecessarily attached to a non-image forming region of the photoreceptor 22, such that deterioration in image quality or the like may occur. The toner attached to the non-image forming region of the photoreceptor 22 is called a fogging toner. Therefore, in general, an electrifying bias (a voltage applied to the electrifier 23) is set to be sufficiently larger than the developing bias (the voltage applied to the developer 24), such that occurrence of the fogging toner is suppressed. The fogging margin is a value corresponding, to a difference between the electrifying bias and the developing bias as shown in the following Expression (2).

Fogging margin=Electrifying bias−Developing bias (2)

(Basic Operation of Image Forming Apparatus)

Next, basic operation of the image forming apparatus t according to the present embodiment will be described.

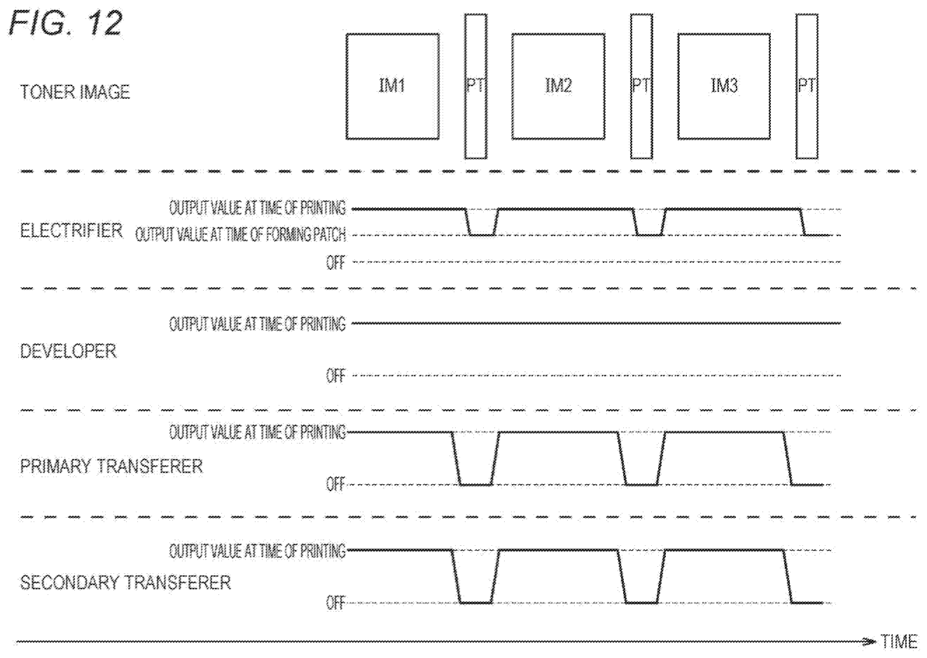

FIG. 12 is a diagram showing an example of a change in voltage over time in a case where the image forming apparatus 1 performs a printing job according to the second embodiment of the present invention, the voltage being applied to each of the electrifier 23, the developer 24, the primary transferer 27, and the secondary transferer 29.

Referring to FIG. 12, the engine control unit 51 forms an electrostatic latent image of each of the print images IM1, IM2, and IM3 by irradiation of laser light from the exposure unit 21 under the control of the MFP controller 52 at a timing at which a region on the surface of the photoreceptor 22, in which the electrostatic latent image of each of the print images IM1, IM2, and IM3 is to be formed, passes through a laser light irradiation region.

Once the printing job starts, the engine control unit 51 applies a voltage corresponding to an output value at the time of printing to each of the electrifier 23 and the developer 24 under the control of the MFP controller 52 (note that output values of the electrifier 23, the developer 24, the primary transferer 27, and the secondary transferer 29 at the time of printing are different from one another). By doing so, the toner images of the print images IM1, IM2, and IM3 are formed on the surface of the photoreceptor 22. The toner images of the print images IM1, IM2, and IM3 are transferred onto the intermediate transfer body 28, and then are sequentially transferred onto the paper passing between the intermediate transfer body 28 and the secondary transferer 29.

Meanwhile, the engine control unit 51 controls a voltage applied to the electrifier 23 to be a voltage corresponding to the output value at the time of forming the patch, without the control of the MFP controller 52 at a timing at which a region on the surface of the photoreceptor 22, in which each of the toner patches PT is to be formed, passes through an electrification region of the electrifier 23. The output value of the electrifier 23 at the time of forming the patch is a value corresponding to the electrifying bias calculated by using Expression (2) on the basis of a value of the fogging margin determined as the toner patch formation condition by a method to be described later. As a result, occurrence of the fogging toner at the time of developing the toner patch PT is suppressed, and a situation in which an excessive amount of toner is attached to the surface of the photoreceptor 22 is suppressed.

The engine control unit 51 controls a voltage applied to the primary transferer 27 to be a voltage at Which the toner patch PT is not transferred onto the intermediate transfer body 28, without the control of the MFP controller 52 at a timing at which a toner image of the toner patch PT formed on the surface of the photoreceptor 22 passes through a region facing the primary transferer 27. By doing so, the most part of the toner of the toner patch PT formed on the surface of the photoreceptor 22 is supplied to the photoreceptor blade 26 and is hardly attached to the intermediate transfer body 28.

The engine control unit 51 controls a voltage applied to the secondary transferer 29 to the a voltage at which the toner patch PT is not transferred onto the secondary transferer 29, without the control of the MFP controller 52 at a timing at which the toner image of the toner patch PT formed on the surface of the intermediate transfer body 28 passes through a region facing the secondary transferer 29. By doing so, the toner of the toner patch PT formed on the surface of the intermediate transfer body 28 remains on the intermediate transfer body 28 and is hardly attached to the secondary transferer 29.

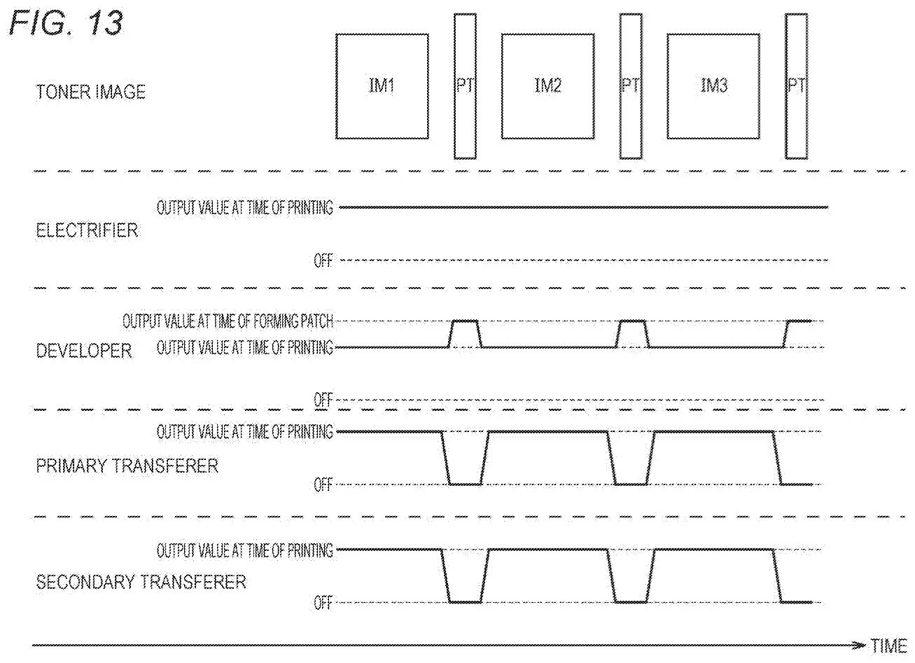

Further, the voltage applied to the developer 24 may be controlled as shown in FIG. 13, instead of controlling the voltage applied to the electrifier 23 at the time of forming the toner patch PT as shown in FIG. 12.

FIG. 13 is a diagram showing another example of the change in voltage over tune in a case where the image forming apparatus 1 performs a printing job according to the second embodiment of the present invention, the voltage being applied to each of the electrifier 23, the developer 24, the primary transferer 27, and the secondary transferer 29.

Referring to FIG. 13, the engine control unit 51 controls a voltage applied to the developer 24 to be a voltage corresponding to the output value at the time of forming the patch, without the control of the MFP controller 52 at a timing at which a region on the surface of the photoreceptor 22, in which each of the toner patches PT is to be formed, passes through a developing region of the developer 24. The output value of the developer 24 at the time of forming the patch is a value corresponding to the developing bias calculated by using Expression (2) oil the basis of a value of the fogging margin determined as a toner patch supplying condition by the method to be described later. As a result, occurrence of the fogging toner at the time of developing the toner patch PT is suppressed, and a situation in which an excessive amount of toner is attached to the surface of the photoreceptor 22 is suppressed.

(Method of Determining Fogging Margin)

Next, a method of determining the fogging margin according to the present embodiment will be described.

The engine control unit 51 determines the environment value on the basis of the absolute humidity value acquired from the environment sensor 53 by using the environment value table when determining the toner patch formation condition. Next, the engine control unit 51 determines a reference fogging margin by using a reference fogging margin table. The reference fogging margin is determined on the basis of the resolution of the print image, the peripheral speed (rotation speed) of the photoreceptor, the color of the toner image formed on the photoreceptor, the cumulative number of rotations of the photoreceptor 22 acquired from the life manager 54, and the environment value determined by using the environment value table.

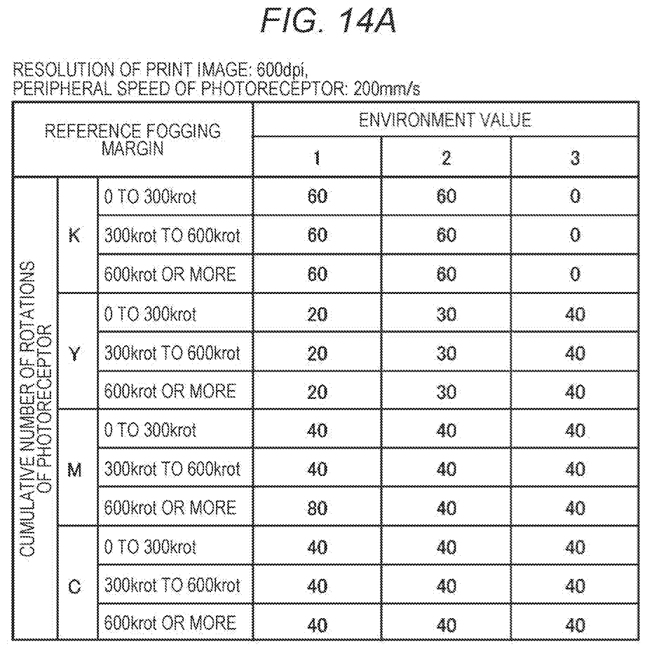

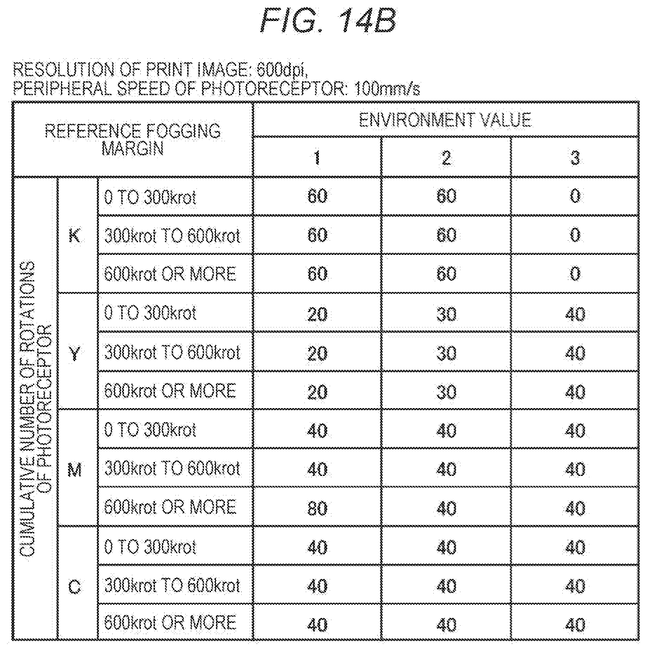

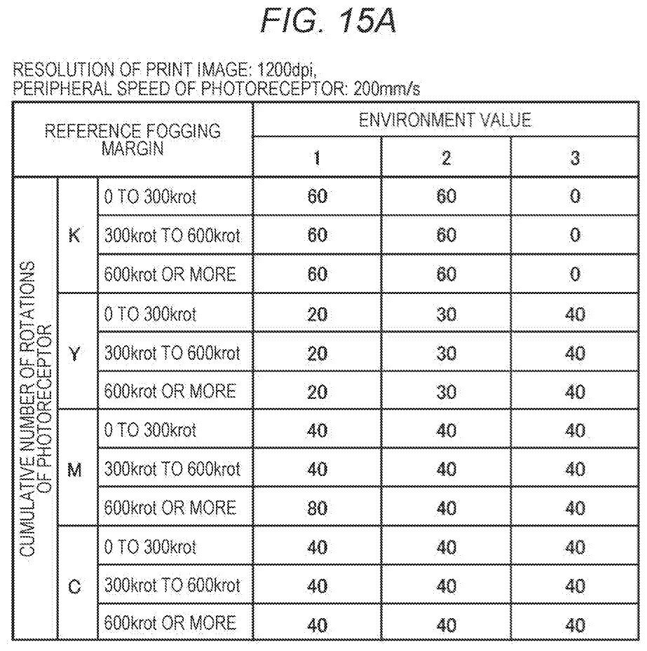

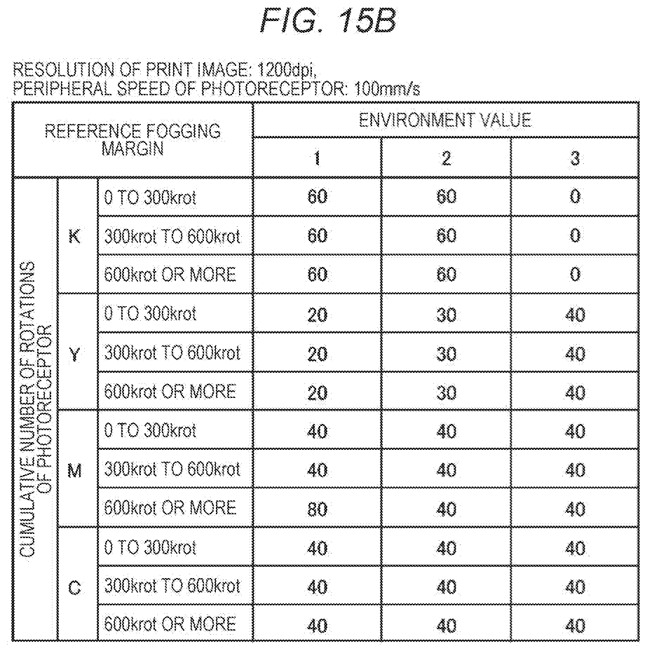

FIGS. 14A to 15B each schematically show a reference fogging margin table stored in the ROM 51b according to the second embodiment of the present invention.

Referring to FIGS. 14A to 15B, the reference fogging margin table is a table describing a relation between the fogging margin, and the resolution of the print image, the peripheral speed of the photoreceptor 22, the color of the toner image formed on the photoreceptor 22, the cumulative number of rotations of the photoreceptor 22 acquired from the life manager 54, and the environment value determined by using the environment value table. The reference fogging margin table defines a fogging margin which is a reference for supplying, to the photoreceptor blade 26, the toner in an amount which does not cause the FD stripe and the back-side contamination.

Specifically, four reference fogging margin tables are shown in FIGS. 14A to 15B, respectively. In a case where the resolution of the print image is 600 dpi, the reference fogging margin tables of FIGS. 14A and 14B are referred to, and in a case where the resolution of the print image is 1200 dpi, the reference fogging margin tables of FIGS. 15A and 15B are referred to. In a case where the peripheral speed (rotation speed) of the photoreceptor is 200 mails, the reference fogging margin table of FIG. 14A or 15A in which “peripheral speed of photoreceptor: 200 mm/s” is described is referred to, and in a case where the peripheral speed of the photoreceptor is 100 mm/s, the reference fogging margin table of FIG. 14B or 15B in which “peripheral speed of photoreceptor: 100 mm/s” is described is referred to.

In one reference fogging margin table, the color of the toner image formed on the photoreceptor, and the cumulative number of rotations of the photoreceptor are divided in a vertical direction. The color of the toner image formed on the photoreceptor is divided into four colors of KYMC, and the cumulative number of rotations of the photoreceptor is divided into three ranges of less than 300 krot, 300 krot or more and less than 600 krot, and 600 krot or more. In one reference fogging margin table, the environment value is divided into three values of 1 to 3 in a horizontal direction.

As an example, in a case where the resolution of the print image is 600 dpi, the peripheral speed of the photoreceptor is 200 mulls, the color of the toner image formed on the photoreceptor is M, the cumulative number of rotations of the photoreceptor is 300 krot or more and less than 600 krot, and the environment value is “2”, the reference fogging margin is determined to be “40 (V)”.

The engine control unit 51 may apply the electrifying bias and the developing bias calculated on the basis of the determined reference fogging margin to the electrifier 23 and the developer 24, respectively, at the time of forming the toner patch. Further, the engine control unit 51 may correct the determined reference fogging margin on the basis of at least one of the developing bias and the laser light intensity at the time of forming the toner image based on the print image. In this case, the engine control unit 51 may apply the electrifying bias and the developing bias calculated on the basis of the corrected reference fogging margin to the electrifier 23 and the developer 24, respectively, at the time of forming the toner patch.

Next, a method of correcting the reference fogging margin according to the present embodiment will be described.

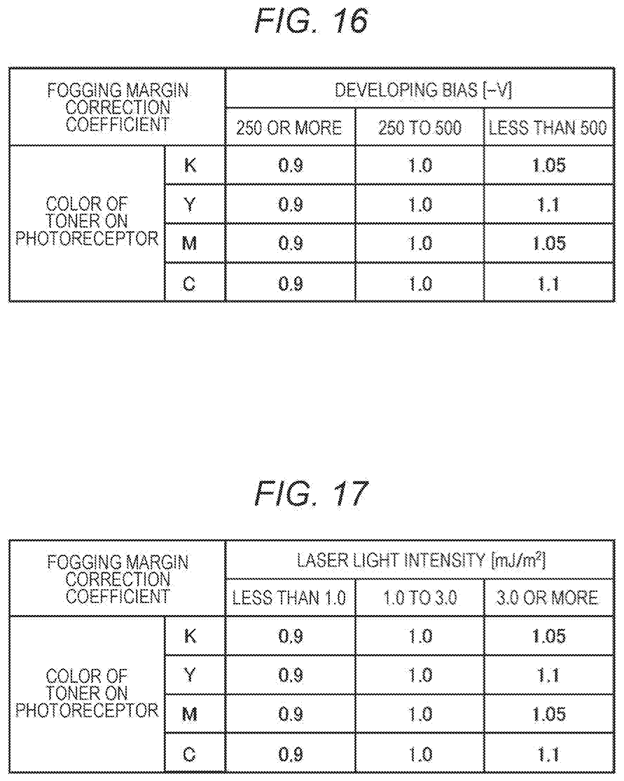

FIG. 16 schematically shows a table of a fogging margin correction coefficient according to a developing bias, the table being stored in the ROM Sib according to the second embodiment of the present invention.

Referring to FIG. 16, the table (hereinafter, referred to as a fogging margin correction coefficient table) of a fogging margin correction coefficient according to a developing bias is a table describing a relation between the developing bias at the time of forming the toner image based on the print image, and the fogging margin correction coefficient. This fogging margin correction coefficient table is provided for correction of the fogging margin determined by using the reference fogging margin table according to a developing characteristic. In this fogging margin correction coefficient table, the color of the toner image formed on the photoreceptor is divided into four colors of KYMC in a vertical direction. Further, in this fogging margin correction coefficient table, the developing bias is divided into three ranges of −250 V or more, −500 V or more and less than −250 V, and less than −500 V in a horizontal direction.

As an example, in a case where the color of the toner image formed on the photoreceptor is K, and the developing bias at the time of forming the toner image based on the print image is less than −500 V, the fogging margin correction coefficient is determined to be “1.05”.

The engine control unit 51 corrects (calculates) the fogging margin at the time of forming the toner patch by using the following Expression (3).

Fogging margin (V) at the time of forming toner patch=Reference fogging margin (V)×Fogging margin correction coefficient (3)

FIG. 17 schematically shows a table of a fogging margin correction coefficient according to a laser light intensity, the table being stored in the ROM 51b according to the second embodiment of the present invention.

Referring to FIG. 17, the table (hereinafter, referred to as a fogging margin correction coefficient table) of a fogging margin correction coefficient according to a laser light intensity is a table describing a relation between the laser light intensity at the time of forming the toner image based on the print image, and the fogging margin correction coefficient. This fogging margin correction coefficient table is provided for correction of the fogging margin determined by using the reference fogging margin table according to an exposure characteristic. In this fogging margin correction coefficient table, the color of the toner image formed on the photoreceptor is divided into four colors of KYMC in a vertical direction. Further, in this fogging margin correction coefficient table, the laser light intensity is divided into three ranges of less than 1.0 mJ/m², 1.0 J/m² or more and less than 3.0 mJ/m², and 3.0 mJ/m² or more in a horizontal direction.

As an example, in a case where the color of the toner image formed on the photoreceptor is K, and the laser light intensity at the time of forming the toner image based on the print image is less than 1.0 mJ/m², the fogging margin correction coefficient is determined to be “0.9”.

The engine control unit 51 corrects (calculates) the fogging margin at the time of forming the toner patch by using Expression (3).

As the fogging margin determined by the above-described method is used at the time of forming the toner patch, the toner is supplied to the photoreceptor blade 26, the fogging margin is appropriately set on the basis of the print image formation condition, and contamination of the secondary transferer 29 with the fogging toner of the toner patch is suppressed.

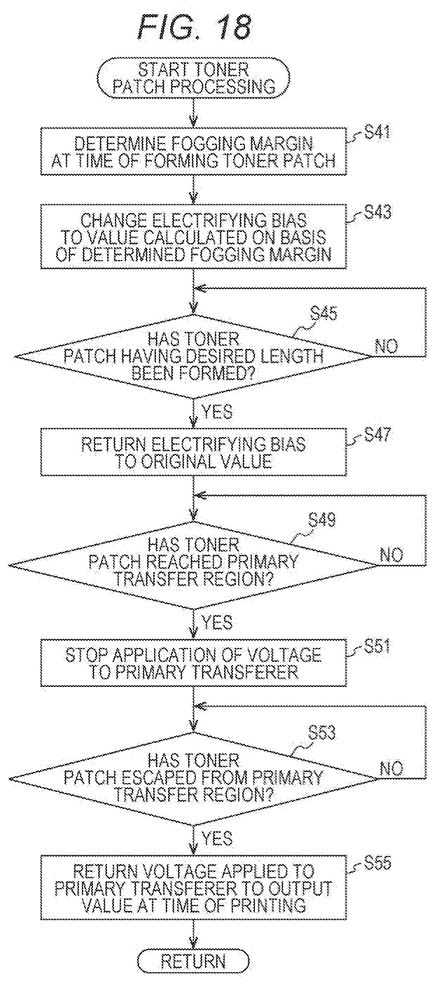

FIG. 18 shows a subroutine of toner patch processing (S5) of FIG. 10 according to the second embodiment of the present invention, which is a subroutine of toner patch processing in a case of controlling the electrifying bias at the time of forming the toner patch.

Referring to FIG. 18, in the toner patch processing, the engine control CPU 51a determines the fogging margin at the time of forming the toner patch (S41), and changes the electrifying bias to a value calculated on the basis of the determined fogging margin (S43). Next, the engine control CPU 51a determines whether or not a toner patch having a desired length has been formed on the surface of the photoreceptor 22 (S45). The engine control CPU 51n repeats the processing of Step S45 until it is determined that the toner patch having the desired length has been formed on the surface of the photoreceptor 22.

In Step S45, in a case where it is determined that the toner patch having the desired length has been formed on the surface of the photoreceptor 22 (YES in S45), the engine control CPU 51a returns the electrifying bias to an original value (S47). Then, the engine control CPU 51a performs processing of Steps S49 to S55 which are the same as those of Steps S29 to S35 of FIG. 11, and returns to the main routine in FIG. 10.

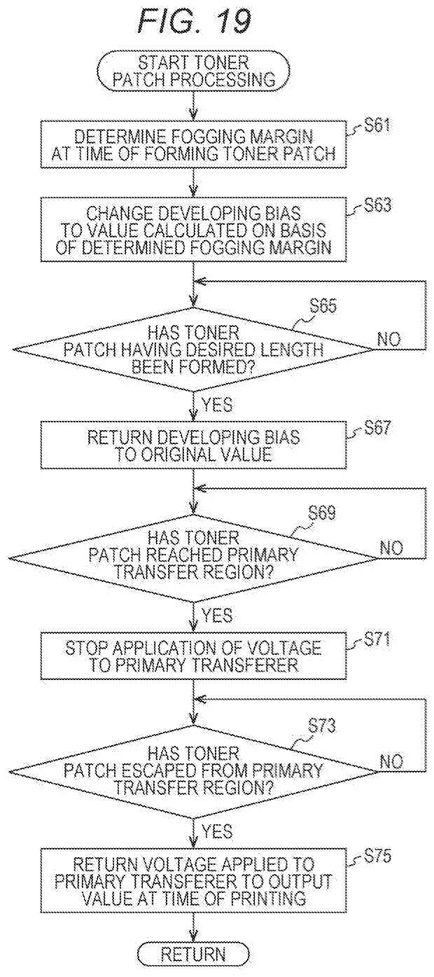

FIG. 19 shows a subroutine of the toner patch processing (S5) of FIG. 10 according to the second embodiment of the present invention, which is a subroutine of toner patch processing in a case of controlling the developing bias at the tune of forming the toner patch.

Referring to FIG. 19, in the toner patch processing, the engine control CPU 51a determines the fogging margin at the time of forming the toner patch (S61), and changes the developing bias to a value calculated on the basis of the determined fogging margin (S63). Next, the engine control CPU 51a determines whether or not a toner patch having a desired length has been formed on the surface of the photoreceptor 22 (S65). The engine control CPU 51n repeats the processing of Step S65 until it is determined that the toner patch having the desired length has been formed on the surface of the photoreceptor 22.

In Step S65, in a case where it is determined that the toner patch having the desired length has been formed on the surface of the photoreceptor 22 (YES in S65), the engine control CPU 51a returns the developing bias to an original value (S67). Then, the engine control CPU 51.a performs processing of Steps S69 to S75 Which are the same as those of Steps S29 to S35 of FIG. 11, and returns to the main routine in FIG. 10.

Other configuration and operation of the image forming apparatus t according to the present embodiment are the same as those of the image forming apparatus according to the first embodiment, and thus an overlapping description thereof will be omitted.

According to the present embodiment, it is possible to appropriately set the fogging margin at the time of forming the toner patch on the basis of the formation condition at the time of forming the toner image based on the print image on the paper. As a result, the contamination of the secondary transferer 29 with the fogging toner at the time of forming the toner patch is suppressed, such that it is not necessary to frequently perform the cleaning of the secondary transferer 29. As a result, it is possible to suppress occurrence of the back-side contamination and the FD stripe while suppressing the deterioration in productivity. Further, since processing for creating an image of the toner patch is unnecessary, it is possible to suppress the deterioration in productivity. In addition, it is possible to decrease an amount of toner used for the toner patch.

### Third Embodiment

In the present embodiment, the IDC sensor 56 detects the density of the toner patch transferred onto the intermediate transfer body 28, and a toner patch formation condition after the detection performed by the IDC sensor 56 is corrected on the basis of the detected density.

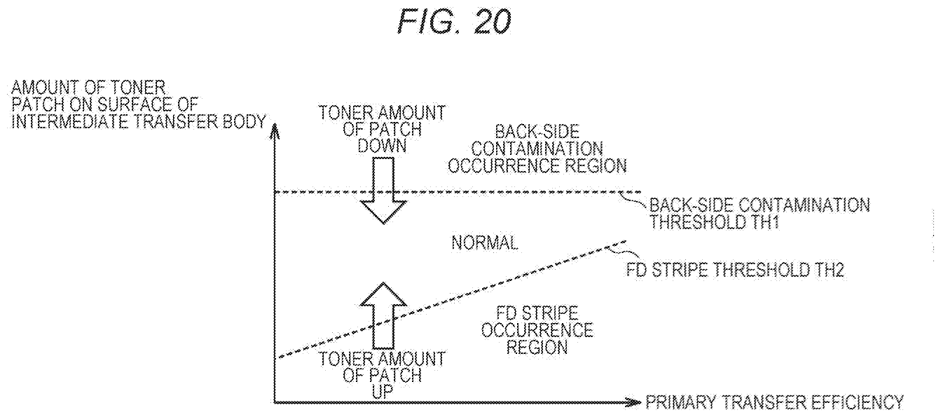

FIG. 20 is a diagram showing a relation between an amount of the toner patch on the surface of the intermediate transfer body 28, and a back-side contamination threshold TH1 and an ED stripe threshold TH2 according to a third embodiment of the present invention.

Referring to FIG. 20, the back-side contamination threshold TH1 is a threshold relating to occurrence and non-occurrence of the back-side contamination (a phenomenon in which the paper is contaminated with the toner attached to the secondary transferer 29). That is, in a case where the amount of the toner patch on the surface of the intermediate transfer body 28 is larger than the back-side contamination threshold TH1, the back-side contamination occurs on the paper. The back-side contamination threshold TH1 is constant regardless of a primary transfer efficiency which is an efficiency in transferring the toner image from the photoreceptor 22 onto the intermediate transfer body 28 by the primary transferer 27.

The FD stripe threshold TH2 (<TH1) is a threshold relating to occurrence and non-occurrence of the FD stripe (residual toner having a striped pattern along a circumferential direction of the surface of the photoreceptor). That is, in a case where the amount of the toner patch on the surface of the intermediate transfer body 28 is smaller than the FD stripe threshold 1112, the FD stripe occurs on the surface of the photoreceptor 22. The FD stripe threshold TH2 becomes large in proportion to the primary transfer efficiency. This is because as the primary transfer efficiency becomes higher, the amount of the toner patch attached to the intermediate transfer body 28 is increased, and the amount of toner of the toner patch supplied to the photoreceptor blade 26 is decreased, such that the FD stripe easily occurs.

Therefore, in a case where the amount of the toner patch on the surface of the intermediate transfer body 28 calculated on the basis of the density detected by the IDC sensor 56 is larger than the back-side contamination threshold TH1, the engine control unit 51 decreases the amount of the toner patch formed on the surface of the photoreceptor 22 after the detection performed by the IDC sensor 56. Further, in a case where the amount of the toner patch on the surface of the intermediate transfer body 28 calculated on the basis of the density detected by the IDC sensor 56 is smaller than the FD stripe threshold TH2, the engine control unit 51 increases the amount of the toner patch formed on the surface of the photoreceptor 22 after the detection performed by the IDC sensor 56.

Note that the amount of the toner patch depends on the length L2 (FIG. 3) of the toner patch and the density of the toner patch as shown in the following Expression (4). Therefore, the amount of the toner patch can be controlled by using at least one of the length. L2 of the toner patch and the density of the toner patch.

Amount (g) of toner patch=Length L2 (m²) of toner patch×Density (g/m²) of toner patch (4)

The length L2 of the toner patch can be changed depending on an exposure time at the time of forming the toner patch. The density of the toner patch can be changed depending on the laser light intensity or the fogging margin at the time of forming the toner patch.

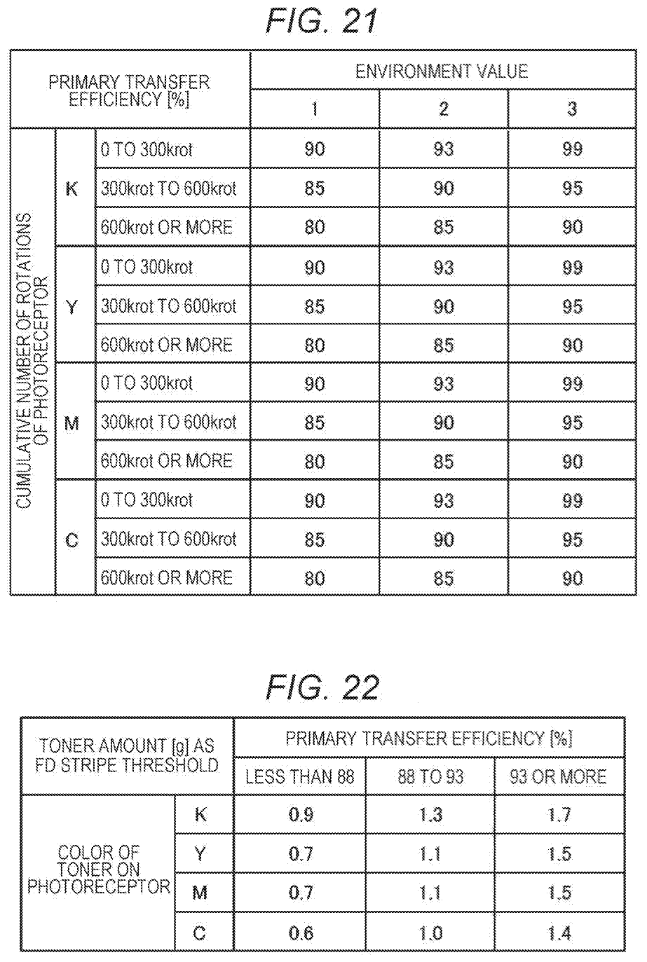

The stripe threshold TH2 is determined by using a primary transfer efficiency table shown in FIG. 21 and an FD snipe threshold table shown in FIG. 22. The FD stripe threshold TH2 is changed according to the primary transfer efficiency.

FIG. 21 schematically shows the primly transfer efficiency table stored in the ROM 51b according to the third embodiment of the present invention.

Referring to FIG. 21, the primary transfer efficiency table is a table describing a relation between the primary transfer efficiency, and the color of the toner image formed on the photoreceptor 22, the cumulative number of rotations of the photoreceptor 22 acquired from the life manager 54, and the environment value determined by using the environment value table. The primary transfer efficiency tends to be decreased in a low-temperature and low-humidity environment and increased in a high-temperature and high-humidity environment, and tends to be decreased as the consumption degree of the photoreceptor is increased.

In the primary transfer efficiency table, the color of the toner image formed on the photoreceptor, and the cumulative number of rotations of the photoreceptor are divided in a vertical direction. The color of the toner image formed on the photoreceptor is divided into four colors of KYMC, and the cumulative number of rotations of the photoreceptor is divided into three ranges of less than 300 krot, 300 krot or more and less than 600 krot, and 600 krot or more. In the primary transfer efficiency table, the environment value is divided into three values of 1 to 3 in a horizontal direction.

As an example, in a case where the color of the toner image formed on the photoreceptor is K, the cumulative number of rotations of the photoreceptor is 300 krot or more and less than 600 krot, and the environment value is “2”, the primary transfer efficiency is determined to be “90(%)”.

Note that in a case where the image forming apparatus 1 includes the IDC sensor 55 that detects the density of the toner image remaining on the surface of the photoreceptor 22 without being transferred, the primary transfer efficiency may be calculated by using the following Expression (5), instead of using the primary transfer efficiency table.

Primary transfer efficiency (%)=(Density of toner image formed on surface of intermediate transfer body 28)/{(Density of toner image remaining on surface of photoreceptor 22)+(Density of toner image formed on surface of intermediate transfer body 28)}×100 (5)

FIG. 22 schematically shows the FD stripe threshold table stored in the ROM 51b according to the third embodiment of the present invention.

Referring to FIG. 22, the FD stripe threshold table is a table describing a relation between the primary transfer efficiency and a toner amount as the FD stripe threshold. In this FD stripe threshold table, the color of the toner image formed on the photoreceptor is divided into four colors of KYMC in a vertical direction. Further, in this ED stripe threshold table, the primary transfer efficiency is divided into three ranges of less than 88%, 88% or more and less than 93%, and 93% or more, in a horizontal direction.

As an example, in a case where the color of the toner image formed on the photoreceptor is K, and the primary transfer efficiency is 93% or more, the FD stripe threshold is determined to be “1.7 (g)”.

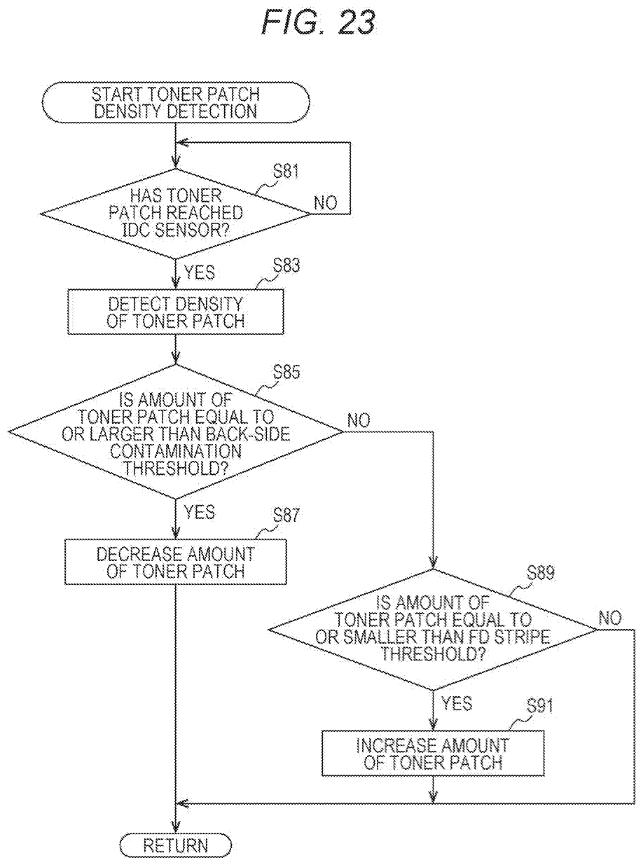

FIG. 23 shows a subroutine of the toner patch density detection processing (S7) of FIG. 10 according to the third embodiment of the present invention.

Referring to FIG. 23, in the toner patch density detection processing, the engine control CPU 51.a determines whether or not the toner patch has reached a detection position of the IDS sensor 56 (581). The engine control CPU 51a repeats the processing of Step S81 until it is determined that the toner patch has reached the detection position of the IDS sensor 56.

In Step S81, in a case where it is determined that the toner patch has reached the detection position of the IDS sensor 56 (YES in S81), the engine control CPU 51a detects the density of the toner patch on the surface of the intermediate transfer body 28 (S83), and determines Whether or not the amount of the toner patch on the surface of the intermediate transfer body 28 is equal to or larger than the back-side contamination threshold (585).

In Step S85, in a case where it is determined that the amount of the toner patch on the surface of the intermediate transfer body 28 is equal to or larger than the back-side contamination threshold (YES in S85), the engine control CPU 51a decreases the amount of the toner patch to be subsequently formed on the surface of the photoreceptor 22 (587), and ends the processing.

In Step S85, in a case where it is determined that the amount of the toner patch on the surface of the intermediate transfer body 28 is smaller than the back-side contamination threshold (NO in S85), the engine control CPU 51a determines whether or not the amount of the toner patch on the surface of the intermediate transfer body 28 is equal to or smaller than the FD stripe threshold (S89).

In Step S89, in a case where it is determined that the amount of the toner patch on the surface of the intermediate transfer body 28 is equal to or smaller than the FD stripe threshold (YES in S89), the engine control CPU 51a increases the amount of the toner patch to be subsequently formed on the surface of the photoreceptor 22 (S91), and ends the processing.

In Step S89, in a case where it is determined that the amount of the toner patch on the surface of the intermediate transfer body 28 is larger than the FD stripe threshold (NO in S89), the engine control CPU 51a returns to the main routine in FIG. 10.

Other configuration and operation of the image forming apparatus 1 according to the present embodiment are the same as those of the image forming apparatus according to the first embodiment, and thus overlapping description thereof will be omitted.

The back-side contamination is caused when a large amount of toner is attached to the intermediate transfer body 28 and the large amount of toner is locally attached to a partial surface of the secondary transferer 29. According to the present embodiment, it is possible to actually detect the amount of the toner attached to the intermediate transfer body 28 at the time of forming the toner patch on the surface of the photoreceptor 22, and reflect a result of the detection to a density of the next toner patch, and thus, it is possible to suppress a situation in which a large amount of toner is attached to the surface of the intermediate transfer body 28, and more effectively suppress the occurrence of the back-side contamination.

### Modified Examples of Third Embodiment

Next, modified examples of the present embodiment will be described.

In first and second modified examples of the present embodiment, a case in which a plurality of toner patches are formed on a plurality (here, four colors of YMCK) of photoreceptors 22, respectively, and the plurality of respective toner patches are overlappingly transferred onto the intermediate transfer body 28 is assumed.

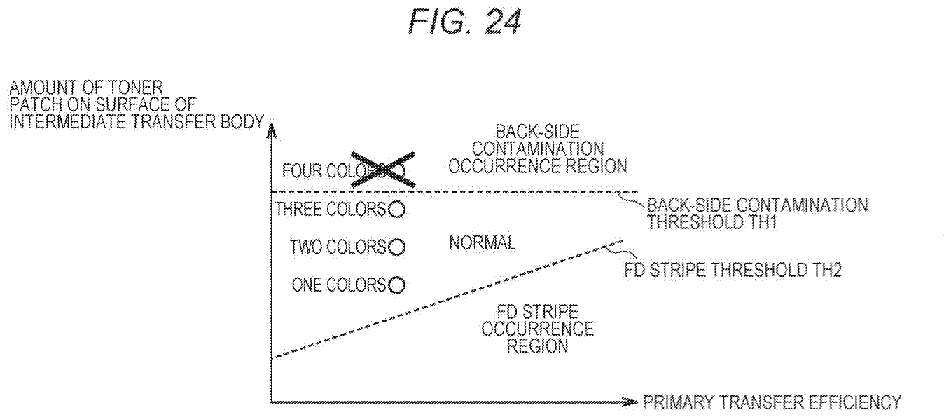

FIG. 24 is a diagram showing a relation between the number of colors of the toner patches overlappingly transferred onto the surface of the intermediate transfer body 28, and the amount of the toner patches on the surface of the intermediate transfer body 28 according to the third embodiment of the present invention.

Referring to FIG. 24, as the number (hereinafter, also referred to as the number of overlapping colors) of colors of the toner patches overlappingly transferred onto the surface of the intermediate transfer body 28 is decreased from four colors to one color, the amount of the toner patches on the surface of the intermediate transfer body 28 at a certain position is decreased. Therefore, in a case where the number of overlapping colors is, for example, four, and the amount of the toner patches on the surface of the intermediate transfer body 28 exceeds the back-side contamination threshold TH1, it is possible to decrease the amount of the toner patches on the surface of the intermediate transfer body 28 to be smaller than the back-side contamination threshold TH1 by decreasing the number of overlapping colors from this point on.

In this regard, in the first modified example of the present embodiment, the engine control unit 51 corrects the number of overlapping colors after the detection performed by the IDC sensor 56, on the basis of the density detected by the IDC sensor 56.

Specifically, in a case where the amount of the toner patch corresponding to the density detected by the IDC sensor 56 is larger than the back-side contamination threshold TH1, the engine control unit 51 decreases the number of overlapping colors after the detection performed by the IDC sensor.

In a case of decreasing the number of overlapping colors, the toner patch may not be formed on the surface of the photoreceptor 22 corresponding to the color (here, C) with the lowest priority among the plurality of photoreceptors 22, when forming the toner patches on time surfaces of the photoreceptors 22 corresponding to the colors (here, Y, M, and K) with high priorities among the plurality of photoreceptors 22, on the basis of priority information (for example, information on priorities of Y, M, K, and C in descending order) stored in the ROM 51b. The priority may be determined on the basis of a possibility of occurrence of the FD stripe.

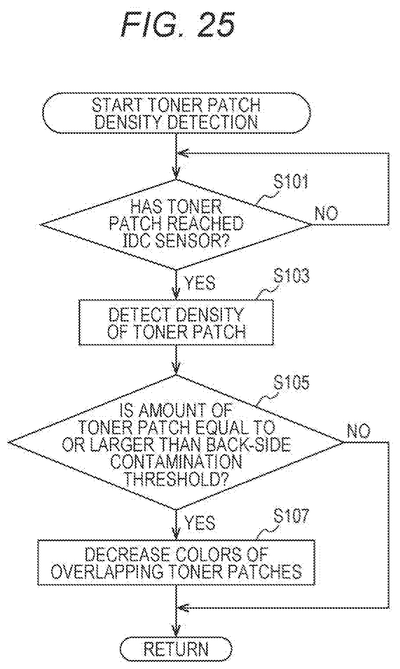

FIG. 25 shows a subroutine of the toner patch density detection processing (57) of FIG. 10 according to the first modified example of the third embodiment of the present invention.

Referring to FIG. 25, in the toner patch density detection processing, the engine control CPU 51a determines whether or not the toner patch has reached the detection position of the IDS sensor 56 (S101). The engine control CPU 51a repeats the processing of Step S101 until it is determined that the toner patch has reached the detection position of the IDS sensor 56.

In Step S101, in a case where it is determined, that the toner patch has reached the detection position of the IDS sensor 56 (YES in S101), the engine control CPU 51a detects the density of the toner patch on the surface of the intermediate transfer body 28 (S103), and determines Whether or not the amount of the toner patch on the surface of the intermediate transfer body 28 is equal to or larger than the back-side contamination threshold (S105).

In Step S105, in a case where it is determined that the amount of the toner patch on the surface of the intermediate transfer body 28 is equal to or larger than the back-side contamination threshold (YES in S105), the engine control CPU 51a decreases the number of overlapping colors from this point on (S107), and returns to the main routine in FIG. 10.

In Step S105, in a case where it is determined that the amount of the toner patch on the surface of the intermediate transfer body 28 is smaller than the back-side contamination threshold (NO in S105), the engine control CPU 51a returns to the main routine in FIG. 1C.

According to the first modified example, it is possible to suppress the situation in which a large amount of toner is locally attached to the surface of the intermediate transfer body 28 by decreasing the number of overlapping colors, and thus it is possible to more effectively suppress the occurrence of the back-side contamination,

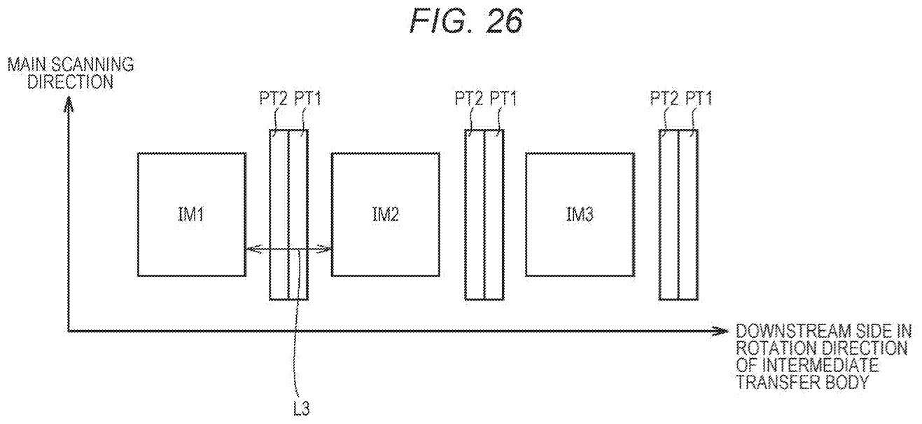

FIG. 26 is a diagram schematically showing toner images formed on the surface of the intermediate transfer body 28 according to the second modified example of the third embodiment of the present invention.

Referring to FIG. 26, in the second modified example of the present embodiment, the engine control unit 51 corrects a position of at least one of the plurality of toner patches transferred onto the intermediate transfer body 28 alter the detection performed by the IDC sensor 56 on the basis of the density detected by the IDC sensor 56, the plurality of toner patches each being formed between the toner images of the plurality of print images.

Specifically, in a case where the amount of the toner patch corresponding to the density detected by the IDC sensor 56 is larger than the back-side contamination threshold TH1, the engine control unit 51 makes a position of at least one of the plurality of toner patches transferred onto the intermediate transfer body 28 be misaligned from positions of other toner patches among the plurality of toner patches, the plurality of toner patches each being formed between the toner images of the plurality of print images IM1, IM2, and IM3.

Here, positions of the toner patches of C and K among the toner patches of YMCK overlappingly transferred onto the intermediate transfer body 28 are misaligned. As a result, a toner patch PT1 obtained by overlappingly transferring the toner patches of Y and M, and a toner patch PT2 obtained by overlappingly transferring the toner patches of C and K are formed side by side between the toner images of the print images IM1, IM2, and IM3, respectively, on the surface of the intermediate transfer body 28 after the detection performed by the IDC sensor 56. As a result, the number of overlapping colors of each of the toner patches PT1 and PT2 is decreased.

Note that the toner patch PT2 may be misaligned from the toner patch PT1 toward a downstream side in the rotation direction of the intermediate transfer body 28, or may be misaligned from the toner patch PT1 toward an upstream side in the rotation direction of the intermediate transfer body 28. Further, the toner patch PT2 may be separate from the toner patch PT1, or may abut the toner patch PT1.

Meanwhile, each of the intervals L3 between the toner images of the print images IM1, IM2, and IM3 needs to be sufficiently large in order to form the toner patches of all colors desired to be formed, by a method in which the positions of the toner patches are misaligned as shown in FIG. 26. Therefore, the engine control unit 51 may change a toner patch formation method depending on whether or not each of the intervals L3 between the toner images of the print images IM1, IM2, and IM3 satisfies the following Expression (6).

Interval L3≤Value S×Length L2 of toner patch+Moving distance of intermediate transfer body corresponding to time required for change of output value between when forming print image, and when forming toner patch (6)

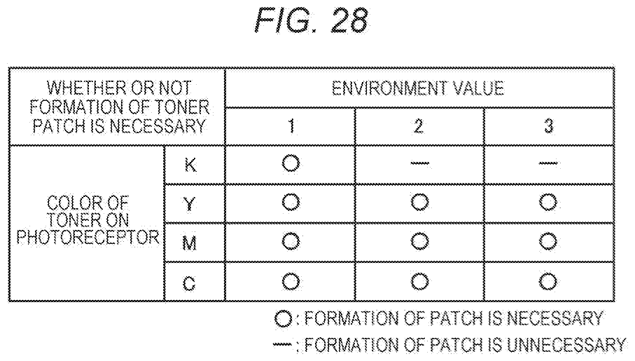

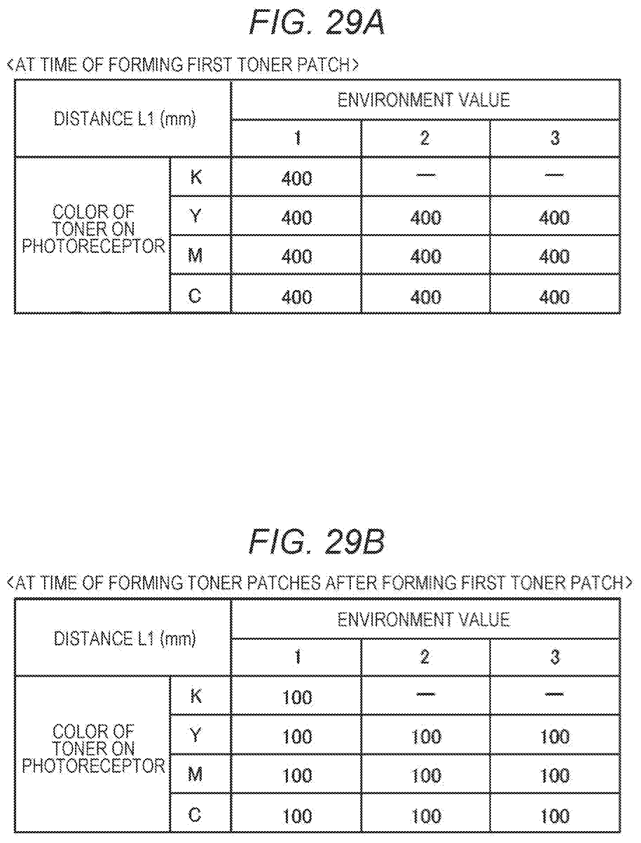

The value S in Expression (6) is an integer obtained by rounding up a calculation result of “the number of colors of the toner patches desired to be formed in one interval L3/maximum number of overlapping colors that does not cause the back-side contamination” to a whole number. The number of the colors of the toner patches desired to be formed in one interval L3 is generally “four” (the total number of photoreceptors 22 in the image forming apparatus 1), but may also be determined by using a patch formation necessity determination table (FIG. 28) or a patch formation timing table (FIGS. 29A and 293) to be described later.

In a case where the interval L3 satisfies Expression (6), since the interval L3 is sufficiently large, the image forming apparatus 1 is in a state in which the toner patches of all colors desired to be formed can be formed in one interval L3 without causing the back-side contamination. In this case, the engine control unit 51 forms, in one interval L3, the toner patches of all colors desired to be formed by the method in which the positions of the toner patches are misaligned as shown in FIG. 26.

Meanwhile, in a case where the interval L3 does not satisfy Expression (6), since the interval L3 is small, the image forming apparatus 1 is in a state in Which the toner patches of all colors desired to be formed cannot be formed in one interval L3 without causing the back-side contamination. In this case, the engine control unit 51 forms only toner patches of which the number is the maximum number of overlapping colors that does not cause the back-side contamination in one interval L3. In this case, the toner patches of the respective colors may be sequentially formed, in the plurality of intervals L3, respectively, on the plurality of photoreceptors 22 from the toner patch of the color with the highest priority on the basis of the priority information stored in the ROM 51b.

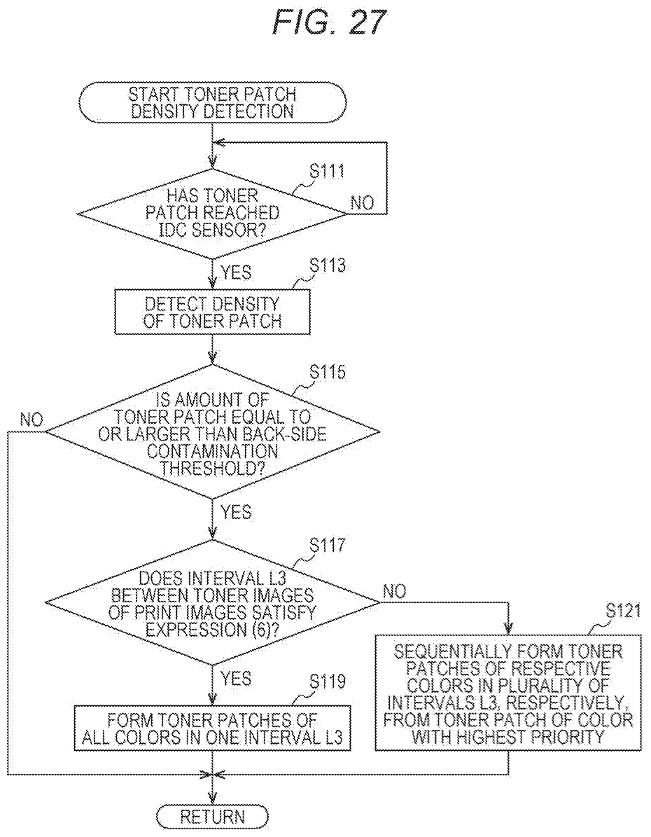

FIG. 27 shows a subroutine of the toner patch density detection processing (S7) of FIG. 10 according to the second modified, example of the third embodiment of the present invention.

Referring to FIG. 27, in the toner patch density detection processing, the engine control CPU Ma determines whether or not the toner patch has reached the detection position of the IDS sensor 56 (S111). The engine control CPU 51a repeats the processing of Step S111 until it is determined that the toner patch has reached the detection position of the IDS sensor 56.

In Step S111, in a case where it is determined that the toner patch has reached the detection position of the IDS sensor 56 (YES in S11), the engine control CPU 51a detects the density of the toner patch on the surface of the intermediate transfer body 28 (S113), and determines whether or not the amount of the toner patch on the surface of the intermediate transfer body 28 is equal to or larger than the back-side contamination threshold (S115).

In Step S115, in a case where it is determined that the amount of the toner patch on the surface of the intermediate transfer body 28 is smaller than the back-side contamination threshold (NO in Slit 5), the engine control CPU 51a returns to the main routine in FIG. 10.

In Step S115, in a case where it is determined that the amount of the toner patch on the surface of the intermediate transfer body 28 is equal to or larger than the back-side contamination threshold (YES in S115), the engine control CPU 51a determines whether or not the interval L3 between the print images satisfies Expression (6) (S117).

In Step S117, in a case where it is determined that the interval L3 between the print images satisfies Expression (6) (YES in S117), the engine control CPU 51a forms, in one interval L3, the toner patches of all colors desired to be formed by the method in which the positions of the toner patches are misaligned (S119), and returns to the main routine in FIG. 10.

In Step S117, in a case where it is determined that the interval L3 between the mint images does not satisfy Expression (6) (NO in S117), the engine control CPU 51a sequentially forms the toner patches of the respective colors in the plurality of intervals L3, respectively, from the toner patch of the color with the highest priority (S121), and returns to the main routine in FIG. 10.

According to the second modified example, it is possible to suppress the situation in which a large amount of toner is locally attached to the surface of the intermediate transfer body 28 by dispersing the toner patches on the surface of the intermediate transfer body 28 as needed, and thus it is possible to more effectively suppress the occurrence of the back-side contamination.

### Other Embodiments

(1) The engine control unit 51 may determine whether or not the formation of the toner patch is necessary on the basis of at least one of the consumption degree of the photoreceptor 22, the environment of the image forming apparatus 1, and the total number of times of the formation of the toner patch from when the image forming apparatus t starts. Further, in a case where it is determined that the formation of the toner patch is necessary, the toner patch may be formed at a position (at least one of a position between the respective toner images of the plurality of print images in the printing job, and a position next to the toner image of the last print image in the printing job, on the surface of the photoreceptor 22) requiring the formation of the toner patch. As an example, the engine control unit 51 may determine whether or not the formation of the toner patch is necessary by using the patch formation necessity determination table shown in FIG. 28.

FIG. 28 schematically shows the patch formation necessity determination table stored in the ROM 51b according to another embodiment of the present invention.

Referring to FIG. 28, the patch formation necessity determination table is a table describing a relation between whether or not the formation of the toner patch is necessary, and the color of the toner image formed on the photoreceptor 22, and the environment value determined by using the environment value table.

In the patch formation necessity determination table, the color of the toner image formed on the photoreceptor is divided into four colors of KYMC in a vertical direction. In the patch formation necessity determination table, the environment value is divided into three values of 1 to 3 in a horizontal direction.

As an example, in a case where the color of the toner image formed on the photoreceptor is K, and the environment value is “2”, it is determined that the formation of the toner patch is unnecessary.

(2) The engine control unit 51 may determine a timing to form the toner patch on the basis of at least one of the consumption degree of the photoreceptor 22, the environment of the image forming apparatus 1, and the number of toner patches formed from when the printing, job starts. As an example, the engine control unit 51 may determine the timing to form the toner patch by using the patch formation timing table shown in FIG. 28.

FIGS. 29A and 29B each schematically show the patch formation timing table stored in the ROM 51b according to another embodiment of the present invention.

Referring to FIGS. 29A and 29B, the patch formation timing table is a table describing a relation between the distance L1, and the number of toner patches formed from when the printing job starts, the color of the toner image formed on the photoreceptor 22, and the environment value determined by using the environment value table.

The distance L1 is a value indicating a timing to form the toner patch. When forming the first toner patch after the start of the printing job, the distance L1 corresponds to a distance (a distance L1a in FIG. 3) from a position at which the photoreceptor 22 starts to rotate at the time of starting the printing job to a position at which the formation of the toner patch starts. When forming the toner patches after forming the first toner patch after the start of the printing job, the distance L1 corresponds to a distance (a distance L1b in FIG. 3) from a position at which the previous formation of the toner patch ends to a position at which the next formation of the toner patch starts.

Two patch formation timing tables are shown in FIGS. 29A and 29B, respectively. When forming the first toner patch after the start of the printing job, the patch formation timing table of FIG. 29A is referred to, and when forming the toner patches after forming the first toner patch after the start of the printing job, the patch formation timing table of FIG. 29B is referred to.

In one patch formation timing table, the color of the toner image formed on the photoreceptor is divided into four colors of KYMC in a vertical direction. In the patch formation timing table, the environment value is divided into three values of 1 to 3 in a horizontal direction.

As an example, when forming the first toner patch after the start of the printing job, in a case where the color of the toner image formed on the photoreceptor is K, and the environment value is “1”, the distance L1 is determined to be “400 (mm)”.

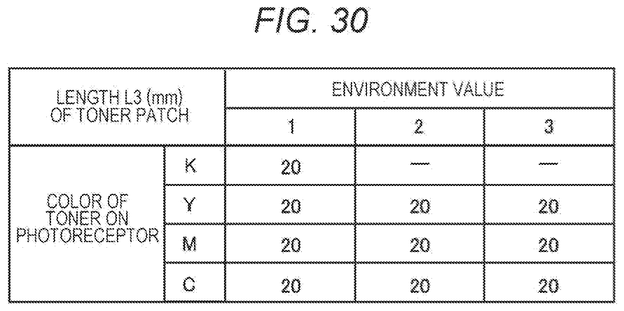

(3) The engine control unit 51 may determine the length L3 of the toner patch on the basis of at least one of the consumption degree of time photoreceptor 22 and the environment of the image forming apparatus 1. As an example, the engine control unit 51 may determine the length L3 of the toner patch by using the patch length table shown in FIG. 30.

FIG. 30 schematically shows time patch length table stored in the ROM Sib according to another embodiment of the present invention.

Referring to FIG. 30, the patch length table is a table describing a relation between the length L3 of the toner patch, and the color of the toner image formed on the photoreceptor 22, and the environment value determined by using, the environment value table.

In the patch length table, the color of the toner image formed on the photoreceptor is divided into four colors of KYMC in a vertical direction. In the patch length table, the environment value is divided into three values of 1 to 3 in a horizontal direction.

As an example, in a case where the color of the toner image formed on the photoreceptor is K, and the environment value is “1”, the length L3 of the toner patch is determined to be “20 (mm)”.

(4) In the image forming apparatus, the toner image formed on the surface of the photoreceptor may be directly transferred (direct transfer method) onto the paper without the intermediate transfer body.

The embodiments and the modified examples described above can be appropriately combined.

Time processing according to the embodiments and the modified examples described above may be performed by using software or a hardware circuit. Further, a program for performing the processing according to the embodiments and the modified examples described above can be provided, and the program may be recorded in a recording medium such as a CD-ROM, a flexible disk, a hard disk, a ROM, a RAM, or a memory card, and provided to a user. The program is executed by a computer such as a CPU. Further, the program may be downloaded to a device through a communication line such as Internet.

Although embodiments of the present invention have been described and illustrated in detail, the disclosed embodiments are made for purposes of illustration and example only and not limitation. The scope of the present invention should be interpreted not by terms of the above described description but by terms of the appended claims, and is intended to include all modifications within the same meaning and range as those of equivalents of the appended claims.

What is claimed is:

1. An image forming apparatus comprising:
a photoreceptor;
a transferer;
a remover that removes toner on a surface of the photoreceptor; and
a hardware processor that:
performs a control to form a toner image based on a print image on paper according to a first formation condition by using at least the photoreceptor and the transferer;
performs a control to form a toner patch on the surface of the photoreceptor according to a second formation condition determined on the basis of the first formation condition at the time of forming the toner image on the paper by the hardware processor; and
controls a voltage applied to the transferer to be a voltage at which the toner patch formed on the photoreceptor is not transferred when the toner patch formed on the surface of the photoreceptor passes through a region facing the transferer.

2. The image forming apparatus according to claim 1, wherein the first formation condition includes a developing bias at the time of forming the toner image based on the print image.

3. The image forming apparatus according to claim 1, wherein the first formation condition includes a laser light intensity at the time of forming the toner image based on the print image.

4. The image forming apparatus according to claim 1, wherein the first formation condition includes at least one parameter among a rotation speed of the photoreceptor, a color of the toner image formed on the photoreceptor, a consumption degree of the photoreceptor, an environment of the image forming apparatus, and a resolution of the print image.

5. The image forming apparatus according to claim 4, further comprising a storage device that stores a table showing a relation between the at least one parameter and the second formation condition.

6. The image forming apparatus according to claim 1, wherein the first formation condition is a condition determined by image stabilization processing performed by the image forming apparatus.

7. The image forming apparatus according to claim 1, wherein the first formation condition is a condition determined on the basis of at least one of an environment of the image forming apparatus and a consumption degree of consumables of the image forming apparatus.

8. The image forming apparatus according to claim 1, further comprising a laser light irradiator that emits laser light for forming an electrostatic latent image as a base of the toner image on the surface of the photoreceptor, wherein the second formation condition is an intensity of the laser light emitted from the laser light irradiator.

9. The image forming apparatus according to claim 1, further comprising:
an electrifier to which an electrifying bias is applied to electrify the surface of the photoreceptor; and
a developer to which a developing bias is applied to develop an electrostatic latent image formed on the surface of the photoreceptor,
wherein the second formation condition is a difference between the electrifying bias and the developing bias.

10. The image forming apparatus according to claim 9, wherein the hardware processor applies the electrifying bias or the developing bias having a magnitude calculated on the basis of the difference.

11. The image forming apparatus according to claim 1, wherein the hardware processor forms the toner patch at at least one of a position between respective toner images of a plurality of print images in a printing job including the plurality of print images, and a position next to the toner image of the last print image in the printing job, on the surface of the photoreceptor.

12. The image forming apparatus according to claim 1, further comprising:
an intermediate transfer body onto which the toner image formed on the photoreceptor is transferred by the transferer; and
a density detector that detects a density of the toner patch transferred onto the intermediate transfer body.

13. The image forming apparatus according to claim 12, wherein the hardware processor corrects the second formation condition after the detection performed by the density detector, on the basis of the density detected by the density detector.

14. The image forming apparatus according to claim 13, wherein in a case where an amount of the toner patch corresponding to the density detected by the density detector is larger than a first threshold, the hardware processor decreases the amount of the toner patch formed on the surface of the photoreceptor after the detection performed by the density detector.

15. The image forming apparatus according to claim 14, wherein in a case Where the amount of the toner patch corresponding to the density detected by the density detector is smaller than a second threshold, the second threshold being smaller than the first threshold, the hardware processor increases the amount of the toner patch transferred onto the surface of the photoreceptor after the detection performed by the density detector.

16. The image forming apparatus according to claim 15, wherein the second threshold is changed according to a primary transfer efficiency, the primary transfer efficiency being a transfer efficiency of the transferer.

17. The image forming apparatus according to claim 12, wherein the number of photoreceptors is plural, and each of the plurality of photoreceptors corresponds to each of a plurality of colors,
a plurality of the toner patches formed on the plurality of photoreceptors, respectively, by the hardware processor are overlappingly transferred onto the intermediate transfer body, and
the hardware processor corrects the number of colors of the plurality of toner patches overlappingly transferred onto the intermediate transfer body after the detection performed by the density detector, on the basis of the density detected by the density detector.

18. The image forming apparatus according to claim 17, wherein in a case where an amount of the toner patches corresponding to the density detected by the density detector is larger than a first threshold, the hardware processor decreases the number of colors of the plurality of toner patches overlappingly transferred onto the intermediate transfer body after the detection performed by the density detector.

19. The image forming apparatus according to claim 18, wherein in a case where the amount of the toner patches corresponding to the density detected by the density detector is larger than the first threshold, the hardware processor prevents the toner patch from being formed on the surface of the photoreceptor corresponding to the color with the lowest priority among the plurality of photoreceptors.

20. The image forming apparatus according to claim 12, wherein the number of photoreceptors is plural, and each of the plurality of photoreceptors corresponds to each of a plurality of colors,
a plurality of toner patches formed on the plurality of photoreceptors, respectively, by the hardware processor are overlappingly transferred onto the intermediate transfer body, and
the hardware processor corrects a position of at least one of the plurality of toner patches transferred onto the intermediate transfer body after the detection performed by the density detector, oil the basis of the density detected by the density detector, the plurality of toner patches each being formed between toner images of a plurality of print images.

21. The image forming apparatus according to claim 20, wherein in a case where an amount of the toner patch corresponding to the density detected by the density detector is larger than a first threshold, the hardware processor makes a position of at least one of the plurality of toner patches transferred onto the intermediate transfer body be misaligned from positions of other toner patches among the plurality of toner patches, the plurality of toner patches each being formed between the toner images of the plurality of print images.

22. The image forming apparatus according to claim 12, further comprising a secondary transferer that transfers the toner image based on the print image from the intermediate transfer body onto the paper, wherein
the hardware processor further controls a voltage applied to the secondary transferer to be a voltage at which the totter patch formed on the intermediate transfer body is not transferred when the toner patch passes through a region facing the secondary transferer.

23. The image forming apparatus according to claim 22, wherein the voltage at which the toner patch formed on the intermediate transfer body is not transferred is a voltage lower than a voltage at the time of forming the toner image of the print image, a zero voltage, or a voltage at which a potential of the secondary transferer becomes the same as that of the toner patch formed on the intermediate transfer body.

24. The image forming apparatus according to claim 1, wherein the voltage at which the toner patch formed on the photoreceptor is not transferred is a voltage lower than a voltage at the time of forming the toner image of the print image, a zero voltage, or a voltage at which a potential of the transferer becomes the same as the toner patch formed on the photoreceptor.

25. The image forming apparatus according to claim 1, wherein the hardware processor determines whether or not formation of the toner patch is necessary on the basis of at least one of a consumption degree of the photoreceptor, an environment of the image forming apparatus, and the total number of times of the formation of the toner patch from when the image forming apparatus starts.

26. The image forming apparatus according to claim 1, wherein the hardware processor determines a timing to form the toner patch on the basis of at least one of a consumption degree of the photoreceptor, an environment of the image forming apparatus, and the number of toner patches formed from when a printing job starts.

27. The image forming apparatus according to claim 1, wherein the hardware processor determines a length of the toner patch on the basis of at least one of a consumption degree of the photoreceptor and an environment of the image forming apparatus.

28. A method for controlling an image forming apparatus including a photoreceptor, a transferer, and a remover that removes toner on a surface of the photoreceptor, the method comprising:
performing a control to form a toner image based on a print image on paper according to a first formation condition by using at least the photoreceptor and the transferer;
performing a control to form a toner patch on the surface of the photoreceptor according to a second formation condition determined on the basis of the first formation condition at the time of forming the toner image on the paper by the performing a control to form a toner image based on a print image on paper; and
controlling a voltage applied to the transferer to be a voltage at which the toner patch formed on the photoreceptor is not transferred when the toner patch formed on the surface of the photoreceptor passes through a region facing the transferer.

29. A non-transitory recording medium storing a computer readable program for controlling an image forming apparatus including a photoreceptor, a transferer, and a remover that removes toner on a surface of the photoreceptor, the program causing a computer to perform:
performing a control to form a toner image based on a print image on paper according to a first formation condition by using at least the photoreceptor and the transferer;
performing a control to form a toner patch on the surface of the photoreceptor according to a second formation condition determined on the basis of the first formation condition at the time of forming the toner image on the paper by the performing a control to form a toner image based on a print image on paper; and
controlling a voltage applied to the transferer to be a voltage at which the toner patch formed on the photoreceptor is not transferred when the toner patch formed on the surface of the photo receptor passes through a region facing the transferer.
